(19) United States
(12) Patent Application Publication
(10) Pub. No.: US 2010/0050820 A1
(43) Pub. Date: Mar. 4, 2010

(54) Ratchet mechanism for turning dual hex nuts simultaneously dual ratchet mechanism

(76) Inventors: Maria Elena Coronado, Valencia, CA (US); Vonda Ann Lee, Murfreesboro, TN (US)

Correspondence Address: Maria Elena Coronado, Unit 102, 25861 Mcbean Parkway, Valencia, CA, 91355-3741, US

(21) Appl. No.: 12/231,510

(22) Filed: Sep. 2, 2008

(51) Int. Cl. B25B 13/46

(52) U.S. Cl. 81/63.1

(57) ABSTRACT

The Dual Ratchet Mechanism will eliminate the need to use a single socket head and rotate back and forth between two hex nuts or other fastening devices that need simultaneous tightening or loosening. This Dual Ratchet Mechanism and Dual Ratchet Mechanism with fixed handle or torque-adjusting handle will increase productivity and technique.

The Dual Ratchet Mechanism or Dual Ratchet Dual Ratchet Mechanism with fixed handle or torque-adjusting handle will eliminate the need to tighten the clamp twice, reducing repetitive motion for the user and possibly reducing injury for the user. The Dual Ratchet Mechanism or Dual Ratchet Mechanism with fixed handle or torque adjusting handle resourcefully reduces labor costs by cutting time and the work effort in half.

### CROSS REFERENCE TO RELATED APPLICATION

This application claims priority to provisional application No. 60/994,129 filed on Sep. 15, 2007.

This Dual Ratchet Mechanism is a single piece adaptor. The Dual Ratchet Mechanism consists of apparatus containing two square male pieces protruding from one side of unit. These pieces mate with various sized sockets and are made in various sizes to accommodate ratchet side of socket. The Dual Ratchet Mechanism will mate with two same sized sockets on that side. The other side of unit has square receiving groove for ratchet to insert square protruding piece and receives ratchet. As ratchet turns, both sockets rotate in same direction to simultaneously turn two hex nuts. The assembly has the following components: housing ratchet side, housing socket side, and three gears. The housings are assembled and press fit. The gears are assembly interconnecting wherein the main gear sits in the middle and is turned by ratchet receiving groove. Said gear is interlocked with the other two gears turning both simultaneously which rotates socket side of unit. The gears will rotate against house bosses respectively from the insert order of information. The inserts and gears will move freely against the housing. As the ratchet is rotated externally, the insert and gear will rotate internally. The result of the rotation is for gear and insert to rotate the two socket heads. The ratchet gear will generate the movement of the socket gears in the opposite direction. The angles on the gear teeth will maximize the interlocking area while given a slight angle to eliminate any possibility of jamming of teeth causing a freezing of the gears. The socket housing contains openings for the socket insert and has a stepped area for the press fit for the ratchet housing. The socket housing contains housing boss, which is used as a rotating device for ratchet insert. The ratchet housing contains an opening for the ratchet insert and has a stepped area for the press fit for the socket housing. The ratchet housing contains two bosses that are used for support for the socket inserts. The gear consists of male and female teeth that will be repeated continually around the gear by 360 degrees and mate with male and female type area of the other gears. One side of the gear in the center has an opening where the inserts will be pressed, socket and ratchet both. The gears for the sockets will be flipped in the opposite direction of the ratchet depending on the press fit direction of the insert into the housings.

The other side of the gear in the center has an opening that will slip over the boss included in the housing. The ratchet insert is a recessed diameter area for the ratchet to mate into the insert. External diameter is press fit into the corresponding gear.

The socket insert is a press fit diameter area that mate with corresponding gears, which would be a total of two for the Dual Ratchet Mechanism. The opposite side of socket insert is the area of the insert that mates with the socket heads.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF INVENTION

The current method for securing wire rope clips and/or other terminology of cable clamps that apply to the dual hex nut design is with a single socket head ratchet. Please see FIG. 2 for visual clarity. The single socket ratchet rotates back and forth from one hex nut to the other while tightening down the nuts to a desired predetermined torque for the given application. This method is functional and adequate but also time consuming which results in additional time and a slow down of productivity on any given job site; this ultimately increases the financial impact.

### BRIEF SUMMARY OF THE INVENTION

The Dual Ratchet Mechanism will eliminate the need to use a single socket head and rotate back and forth between the two hex nuts on the cable clamps. The increase of productivity will result, as the Dual Ratchet Mechanism will allow dual hex nuts to be tightened at the same time. This Dual Ratchet Mechanism is a single piece adaptor that will mate with a range of ratchet heads. The size of the Dual Ratchet Mechanism will not be limited by ratchet size or cable clamp size. The Dual Ratchet Mechanism will be manufactured at the different sizes needed in the field of application. The ratchet and socket housing, gears, and inserts will adjust in size to meet the physical need of the given application. The material used and manufacturing procedures will be specified to meet the durability requirements in the field.

One side of the Dual Ratchet Mechanism will mate with the ratchet, while the other side of the Dual Ratchet Mechanism will have two square male heads that will meet with the ratchet side of the socket. Again, as will the ratchet side, the socket side will be designed to match the size demand of the ratchet being used. As the ratchet is mated with appropriate side of the Dual Ratchet mechanism, the two same sized socket heads will be mated with the other side of the Dual Ratchet Mechanism. As the assembly becomes one working unit it is placed over the hex nuts and the ratchet is rotated resulting in both sockets rotating simultaneously. This continues until the hex nuts are tightened to the specification of the given application.

### BRIEF DESCRIPTION OF THE SEVERAL VIEWS OF THE DRAWING

FIG. 1—Dual Ratchet Mechanism with fixed torque adjusting handle

FIG. 2—a perspective view of the Dual Ratchet Mechanism, as it will be used

FIG. 3—assembled view of the Dual Ratchet Mechanism ratchet side

FIG. 4—assembled view of the Dual Ratchet Mechanism socket side

FIG. 5—sectional view of the Dual Ratchet Mechanism

FIG. 6—internal view of the gear rotation

FIG. 7—sectional view of the socket side of the housing

FIG. 8—sectional view of the ratchet side of the housing

FIG. 9—gear view with sectional

FIG. 10—ratchet insert view with sectional

FIG. 11—Dual Ratchet Mechanism with fixed ratcheting handle

FIG. 12—torque adjusting ratchet mating with Dual Ratchet Mechanism

### DETAILED DESCRIPTION OF THE INVENTION

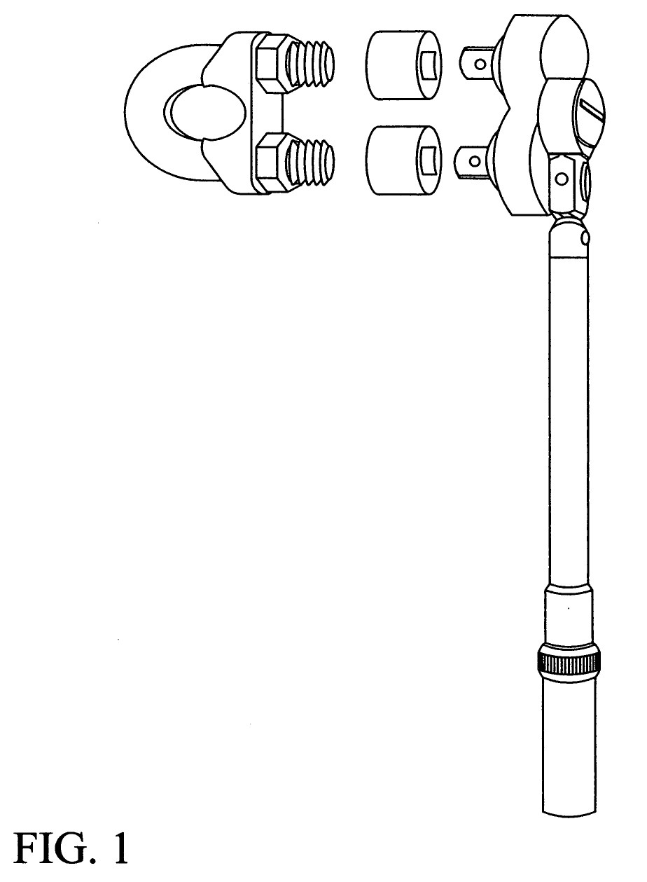

FIG. 1 shows Dual Ratchet Mechanism with fixed torque adjusting handle.

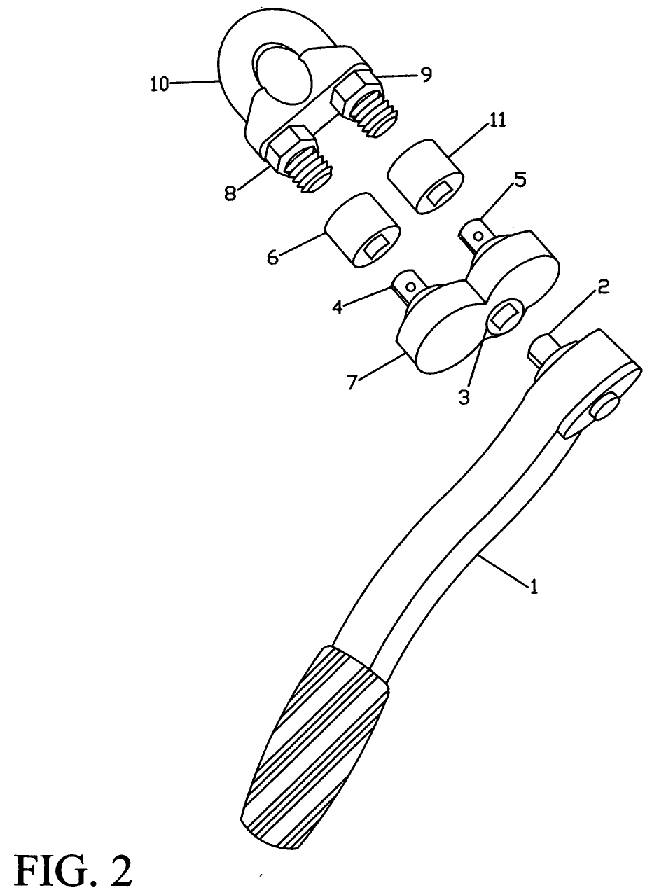

FIG. 2 the perspective view of the physical application usage of the Dual Ratchet Mechanism. Detail 1 is the ratchet of various mounting head size 2 that will mate with the invention at 3. The Dual Ratchet Mechanism 7 has male socket heads 4/5 that will mate with the sockets 6/11. When the ratchet, Dual Ratchet Mechanism, and sockets become one unit it is ready to be used as it was designed. The design function is to rotate the hex nuts 8/9 on the clamp 10, simultaneously until a given tightness is reached. The Dual Ratchet Mechanism will be in multitude of sizes and will tighten, as well as, loosen dual hex nuts on the clamps.

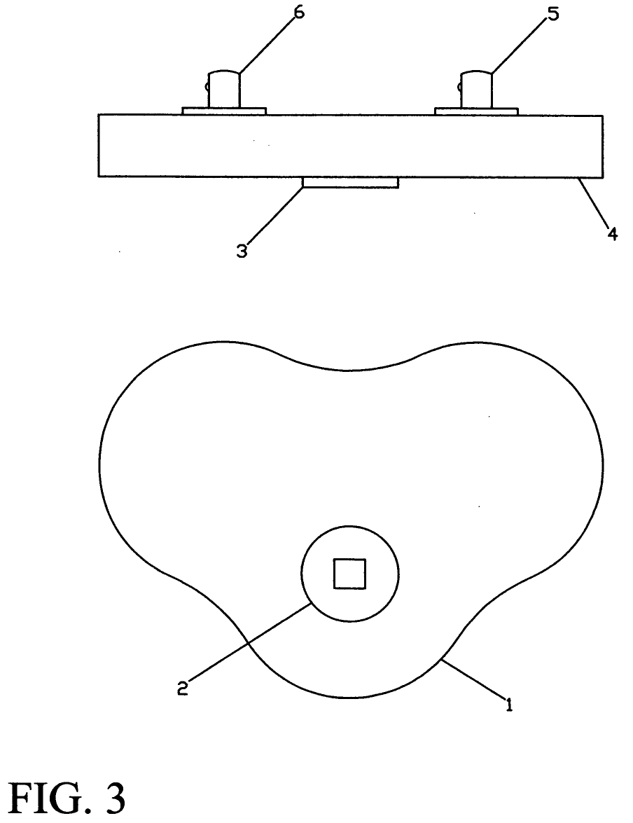

FIG. 3 shows the ratchet view of the Dual Ratchet Mechanism 1. The detail 2 shows the insert for the mating of the ratchet. Top view on FIG. 3 shows the topside view 4 of the ratchet side; giving an overview of the mounting of the sockets 5/6 and ratchet 3.

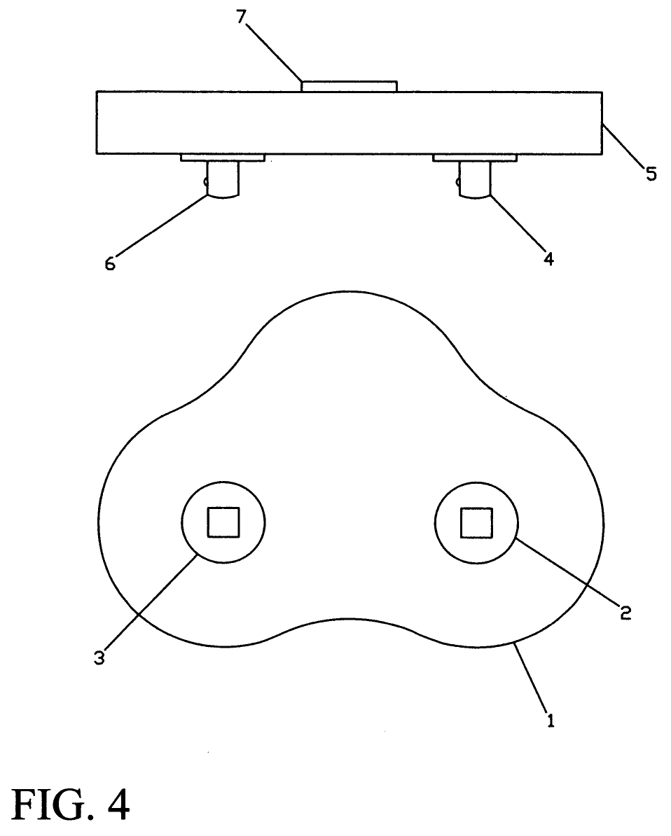

FIG. 4 shows the socket view of the Dual Ratchet Mechanism 1. The detail 2/3 shows the insert for the mating of the sockets. Top view of FIG. 4 shows the bottom side view 5 of the socket side; giving an overview of the mounting of the sockets 4/6 and ratchet 7.

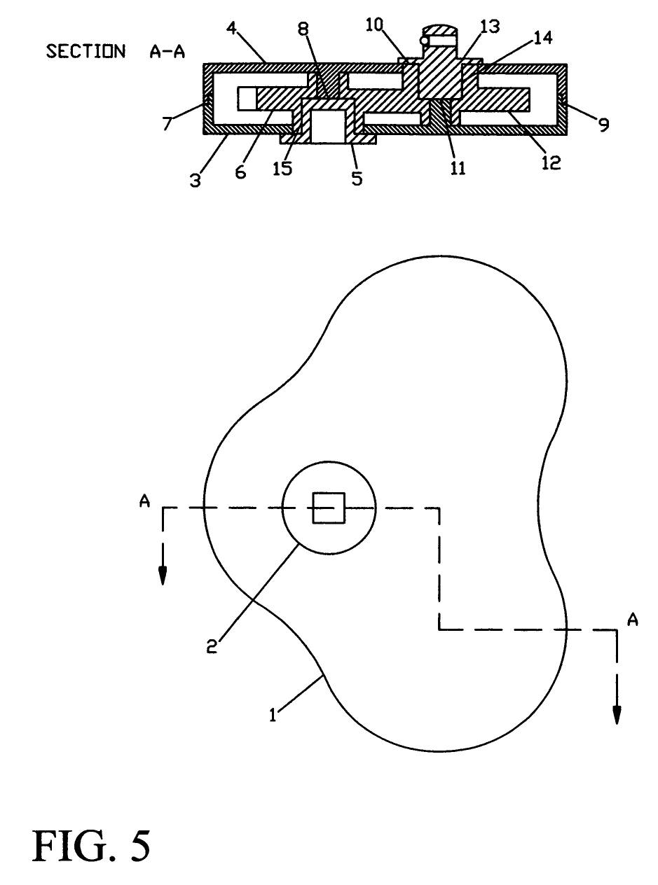

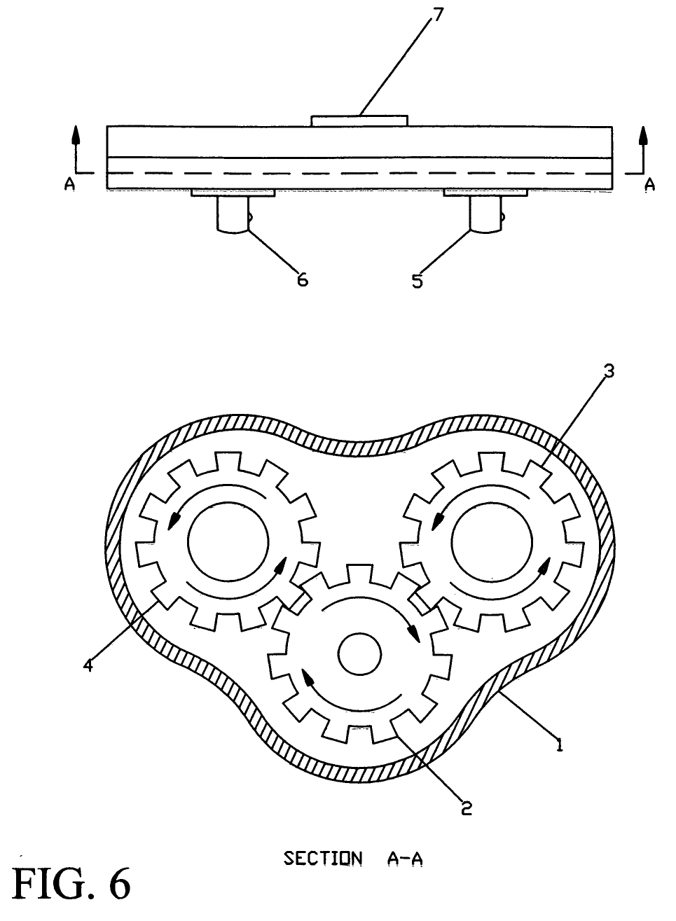

FIG. 5 shows the assembled Dual Ratchet Mechanism 1 in a sectional view A-A. The assembly has the following components: housing ratchet side 3, housing socket side 4, and three gears with two visible from this view 6 and 12, insert ratchet 5, insert socket 13. The housings 3 and 4 are assembled by a press fit 7 and 16. The gears are assembly interconnecting for functionality of the Dual Ratchet Mechanism, this will be clear in FIG. 6. The inserts 5 and 13 are pressed into gear 6 and 12 respectively in the area of 15 and 14 respectively. The gears will rotate against house bosses that are 8 and 11 respectively from the insert order of information. The inserts and gears will move freely against the housing. As the ratchet is rotated externally, the insert 5 and gear 6 will rotate internally. The result of the rotation is for gear 12 and insert 13 to rotate the two socket heads. This ultimately rotates the hex nuts on the cable clamps/wire rope clips simultaneously for maximum efficiency.

FIG. 6 shows the internal functionality of the gears working in conjunction with each other. The ratchet gear will generate the movement of the socket gears in the opposite direction as shown with the arrows in detail 1. The teeth of the gears will be designed to maximize the movement while maintaining a high strength durability of the gears themselves. The angles on the teeth will maximize the interlocking area while given a slight angle to eliminate any possibility of jamming of the teeth causing a freezing of the gears.

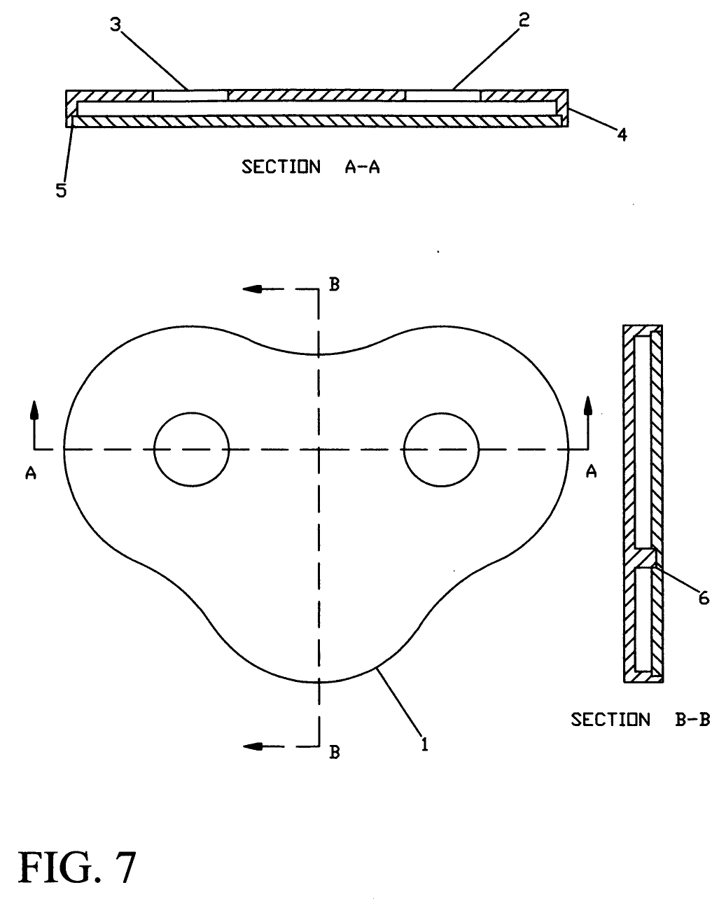

FIG. 7 shows the socket housing 1 with sectional views A-A and B-B. Section A-A shows the sectional view of the openings for the socket insert, and the stepped area for the press fit 5 for the ratchet housing. Section B-B is the sectional view of the housing boss 6, which is used as a rotation device for the ratchet insert.

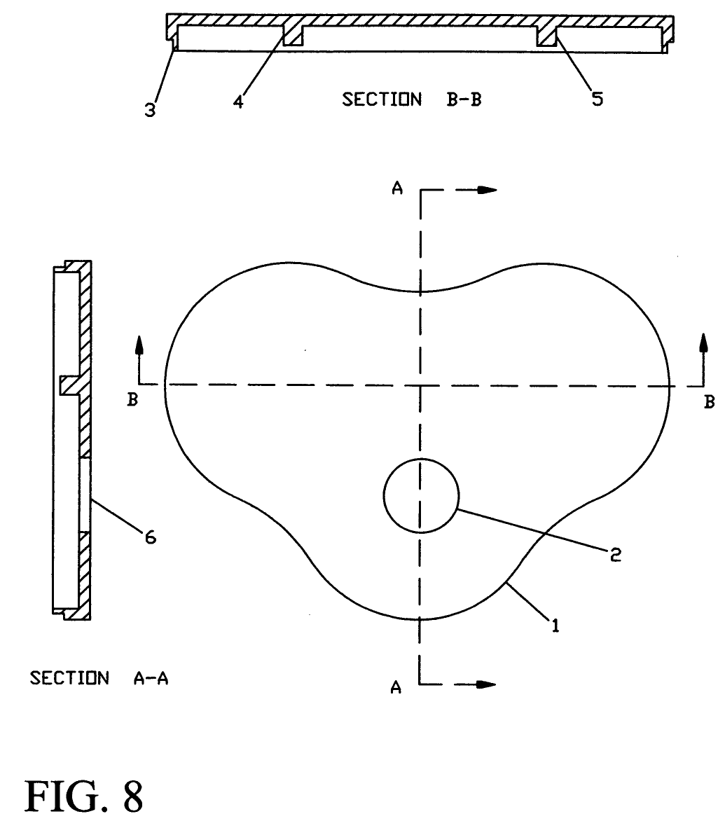

FIG. 8 shows the ratchet housing 1 with sectional views A-A and B-B. Section A-A shows the sectional view of the opening for the ratchet insert. Section B-B shows the sectional view of the stepped area for the press fit 3 for the socket housing. The bosses 4 and 5 are viewed that are used for support for the socket inserts.

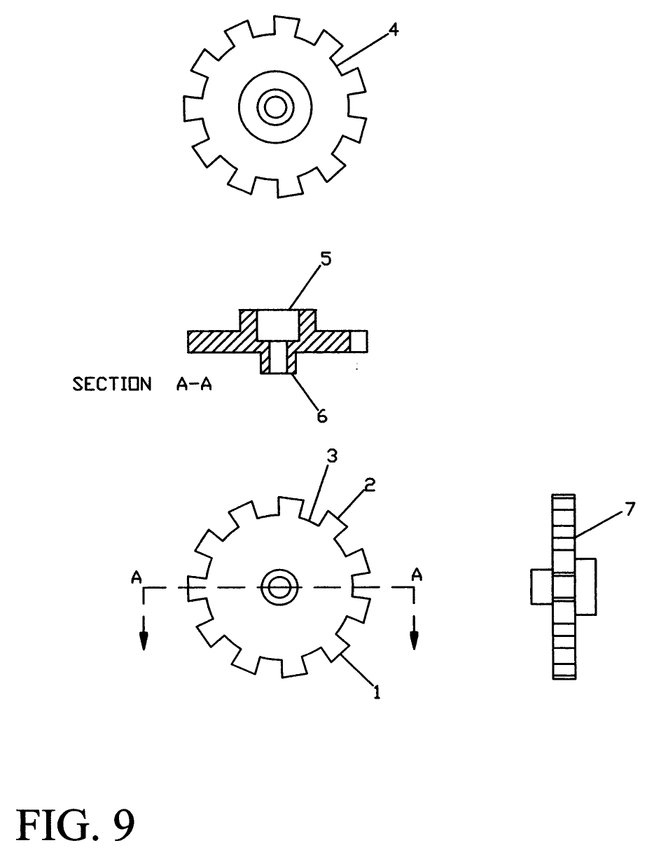

FIG. 9 shows the gear with view 1, 8, and 9, in addition to the sectional view A-A. The detail 2 shows the male teeth and 3 shows the female teeth that 2 and 3 will be repeated continually around the gear by 360 degrees and mate with the male and female type area of the other gears. Section A-A detail 5 is the area where the inserts will be pressed socket and ratchet both. The gears for the sockets will be flipped in the opposite direction of the ratchet, depending on the press fit direction of the insert into the housings. Area detail 6 is the area that will slip over the bosses that are included in the housing.

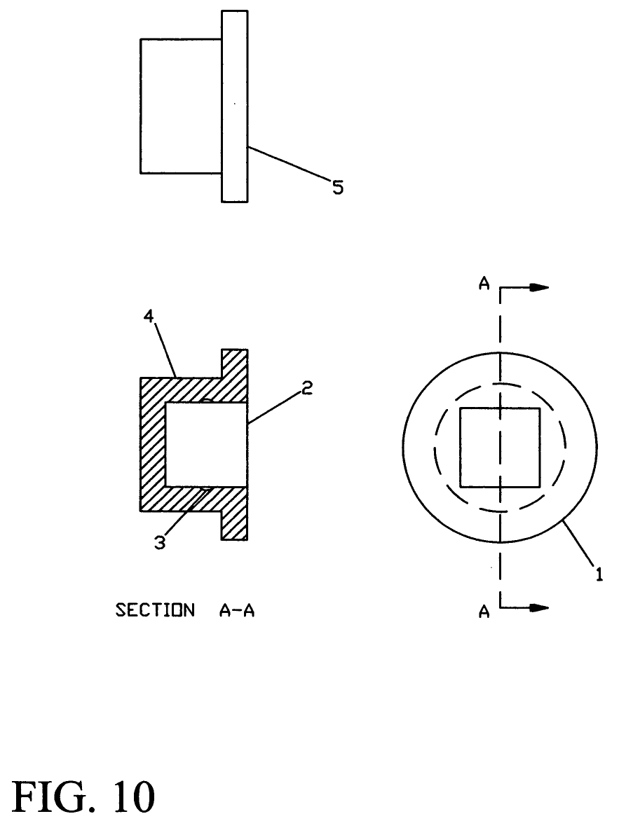

FIG. 10 shows the ratchet insert 1 and 5 with a sectional view A-A. Sectional A-A reveals the detail 3, which is a recessed diameter area for the ratchet to mate into the insert 2. Detail 4 external diameter is pressed fit into the corresponding gear.

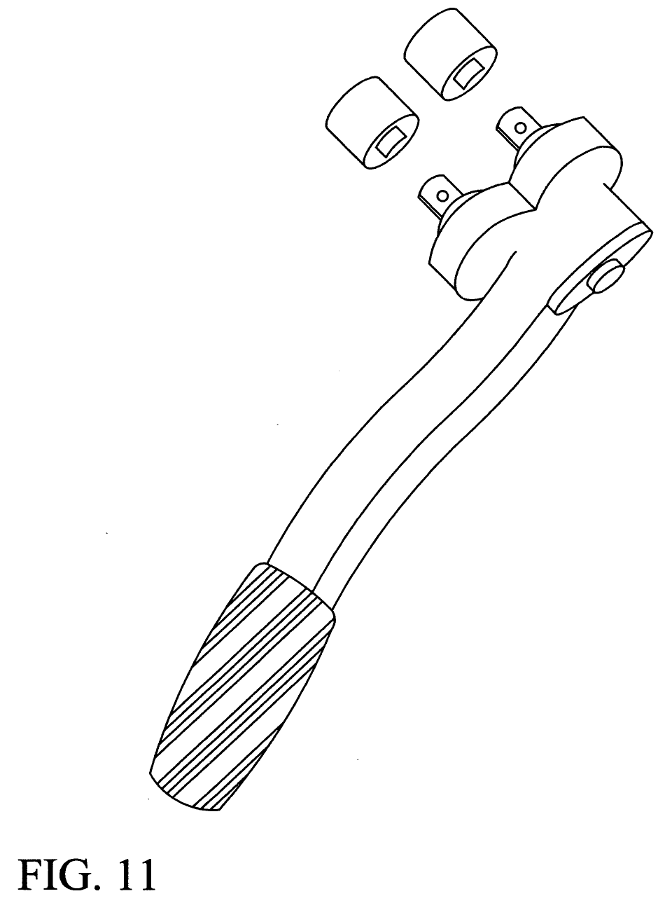

FIG. 11 shows Dual Ratchet Mechanism with fixed handle.

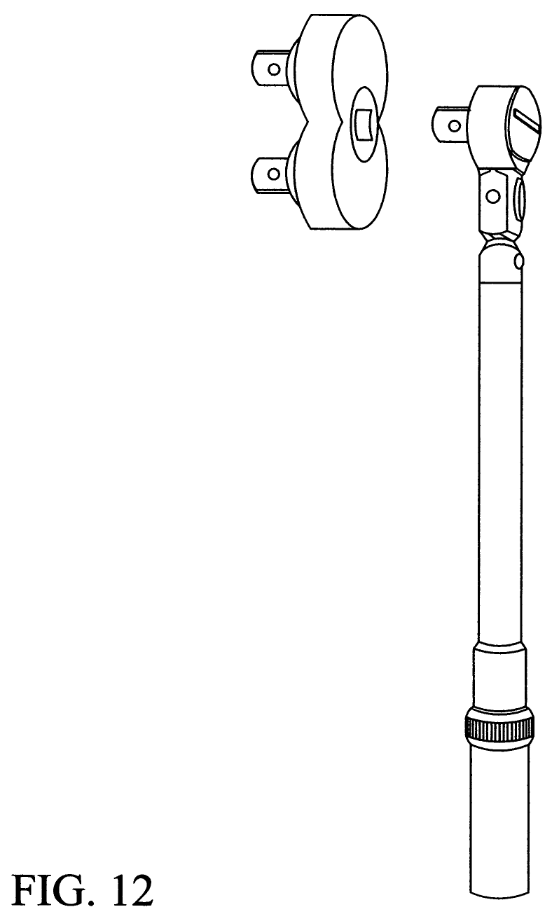

FIG. 12 is a torque-adjusting ratchet mating with Dual Ratchet Mechanism.

1-3. (canceled)

4. Dual Ratchet Mechanism said apparatus for said engaging said two said nuts said simultaneously to said identical said degree of said tightness to said secure said wire rope clip to said wire rope comprising; said housing comprising said two said parts that said unite said together; said housing ratchet side and said housing socket side; said housing ratchet side comprising said tri-circular said formed said housing; said tri-circular said form comprising said partial said circular said segments said formed as one said flat said section of said tri-circular formed said material; said orthogonal said flange said continuously said surrounds said outside said border of said tri-circular said form upon said housing ratchet side; said orthogonal said flange said formed as part of said flat said section of said tri-circular said formed said material orthogonnally in said relation to said outside said face of said flat said section of said tri-circular said formed said material comprising said housing ratchet side; said housing ratchet side comprising said orthogonal flange said continuously said surrounds said outside said border upon said housing ratchet side; said housing ratchet side comprising said upmost portion of said orthogonal said flange comprising said internal said interlocking said indentation said section said continuously said surrounding said outside said surface upon said upmost portion of said orthogonal said flange said housing ratchet side; said housing ratchet side and said housing socket side are said interference said fit said together; when said housing ratchet side and said housing socket side are said interference said fit said together said internal said interlocking said indentation said section said housing ratchet side interlock said housing ratchet side to said housing socket side said external said interlocking said indentation said section; said internal said interlocking said indentation said section being of said sufficient said depth to said correspond to said external interlocking said indentation said section upon said housing socket side; said external said interlocking said section being of said sufficient said size to said readily said receive said external said interlocking said section of said housing socket side; said internal said interlocking said indentation said section being said sufficient said depth to be said workable with said interference said fit said method thereby said securely said locking said two housings said together and said preventing them from said separation; said housing ratchet side comprising said circular said aperture within said center of said lower said segment of said housing ratchet side said circular aperture said circumference said larger than said ratchet insert said circumference to allow said ratchet insert to said rotatably said fit within said circular aperture; said housing ratchet side comprising said center of said circular aperture within said centerline of said width of said housing ratchet side and intersecting said center of said lower circular segment upon said housing ratchet side; said two cylindrical said hubs formed as part of said housing ratchet side are said centered in said center of said upper said left and said right said quadrants of said housing ratchet side and said intersecting said center of said upper said circular segment said hubs are said concentric with said circular said apertures within said housing socket side within said fully assembled said Dual Ratchet Mechanism; two said cylindrical orthogonal said hubs said formed as part of said interior said surface of said housing ratchet side; said cylindrical orthogonal said hubs are orthogonal in relation to said outside said face of said housing ratchet side; said cylindrical orthogonal said hubs said project orthogonnally said beyond said interior said surface said within said housing ratchet side; said upmost portion of said orthogonal said hubs end at said center of said interior said thickness of said fully assembled said Dual Ratchet Mechanism; said cylindrical orthogonal said hubs are concentric with said ratchet inserts and said external idler gears within said fully assembled said Dual Ratchet Mechanism; said housing ratchet side is of sufficient thickness and of proper tensile strength and durability to permit an adequate sheath around said parts of Dual Ratchet Mechanism to endure torque transfer through Dual Ratchet Mechanism; said housing socket side comprising said tri-circular said formed said housing; said tri-circular said form comprising partial said circular said segments formed as one flat said section of tri-circular shaped material; said orthogonal said flange continuously said surrounds said outside said border of said tri-circular said form upon said housing socket side; said orthogonal said flange formed as part of said flat said section of tri-circular said shaped said material orthogonnally in relation to said outside said face of said flat said section of tri-circular said shaped said material comprising said housing socket side; said housing socket side comprising said orthogonal flange said continuously said surrounds said outside said border upon said housing socket side; said housing socket side comprising said upmost portion of said orthogonal said flange comprising said external said interlocking said indentation said section said continuously said surrounding said outside said surface upon said upmost portion of said orthogonal said flange said housing socket side; said housing socket side and said housing ratchet side are said interference fit together; when said housing socket side and said housing ratchet side are said interference said fit together said external said interlocking said indentation said section housing socket side said interlock said housing socket side to said housing ratchet side internal said interlocking said indentation said section; said external interlocking indentation said section being of said sufficient said depth to said correspond to said internal said interlocking said indentation section upon said housing ratchet side; said internal said interlocking said section being of said sufficient said size to said readily receive said internal interlocking said portion of said housing ratchet side; said external said interlocking said indentation said section being said sufficient said depth to be said workable with said interference said fit said method thereby said securely said locking said two said together and said preventing them from said separation; housing socket side comprising said two said circular said apertures in the said center of the upper left and right quadrant of said housing socket side and one said cylindrical orthogonal said hub formed as part of interior surface within said housing socket side; said cylindrical orthogonal said hub is orthogonal in relation to said outside said face of said housing ratchet side; said cylindrical orthogonal said hub said projects orthogonnally said beyond said interior said surface within said housing socket side; upmost portion of said orthogonal said hub ends at center of interior said thickness of said fully assembled said Dual Ratchet Mechanism; said cylindrical orthogonal hub said concentric with said ratchet insert and said circular said aperture within said housing ratchet side within said fully assembled said Dual Ratchet Mechanism; said housing socket side is of sufficient thickness and of proper tensile strength and durability to permit an adequate sheath around said parts of Dual Ratchet Mechanism to endure torque transfer through Dual Ratchet Mechanism; said housing ratchet side having said single said compelling said member said projecting orthogonnally from said face of said housing socket side; one ratchet insert comprising two said opposite said sections is said single said compelling said member centered in said circular said aperture upon said back said lower said segment of said fully assembled said housing ratchet side; one said section of said socket insert comprising said output stud said projecting from said center of said circumferential said flange said hereinafter said explained; said output stud said operatively said connects to said square said aperture of said device; said output stud section upon said socket insert comprising said detent; said fully assembled said Dual Ratchet Mechanism said output stud upon said socket insert said projects said beyond said outside said face of said housing socket side orthogonnally; said output stud said rotates said generally said perpendicularly with said respect to said axis about which said socket insert rotates; upon said fully assembled said Dual Ratchet Mechanism said bottommost portion of said output stud is said flush with said outside said face of said housing socket side; said bottommost portion of said output stud is said upmost portion of said cylindrical said step; said fully assembled said Dual Ratchet Mechanism said upmost portion of said cylindrical said step flush with said face of said housing ratchet side ;said thickness of said cylindrical said step is of said greater said thickness than said housing ratchet side to said permit said adequate free said movement of said parts said relative to each other; said outside said diameter of said step is said clearance fit in said circular said aperture of said housing socket side and is of said identical said outside said diameter as said outside said diameter of said smooth said cylindrical said outer said surface upon said opposite said section of said socket insert; said opposite said section of said socket insert comprising said smooth said cylindrical outer surface; said smooth said cylindrical said outer said surface begins at said bottommost portion of said circumferential said flange and said surrounds said entire said smooth said cylindrical said outer said surface to be said interference said fit into said gear; said smooth said cylindrical said outer said surface said formed to be said interference said fit against said inner said diameter of said larger said diameter said cylindrical said bore in said center said gear; said socket insert said interference fit said securely into said center of said external idler gear by said interference said fit said method; said external idler gear said rotatably said mounted upon said cylindrical orthogonal said hub to said interior of said housing ratchet side said opposite said socket insert; said socket insert said connects to said rotating said device and said transfers said rotation of said device from said Dual Ratchet Mechanism said apparatus transmitting said two said compelled said members in said parallel said relationship relative to one another located within said upper left and said right quadrant of said housing socket side are said internally orthogonal in relation to said face of said housing socket side and said centered in said two said circular said apertures within said fully assembled said Dual Ratchet Mechanism; said two said ratchet inserts comprising said two said opposite said sections are two said compelled said members in said parallel said relationship said relative to one another; said one said section of said ratchet insert comprising said square said aperture sheathed in said smooth said cylindrical said outer said surface; said square said aperture said centered within said circumferential said flange said hereinafter explained; said square said aperture said operatively said connects with said output stud of said device; said every said interior said surface of said square said aperture in said ratchet insert includes any said piano-concave said dado said horizontally said aligned upon said every said interior said surface upon said square said aperture; said piano-concave said dado said forms said square said ring said parallel with said face of said housing ratchet side; said piano-concave dado said operatively said connects with said detent from said device; said detent said operatively connects with said plano-concave said dado upon any of said orthogonal said interior surface of said square said aperture in said ratchet insert; said orthogonal said interior surface of said square said aperture in said ratchet insert orthogonal in relation to said outside said outside face of said housing socket side; said fully assembled said Dual Ratchet Mechanism said square said aperture within said ratchet insert are said internally orthogonal in said relation to said outside face of said housing ratchet side; said square said aperture said rotates generally said perpendicularly with respect to said axis about which said ratchet insert said rotates; said upmost portion of said ratchet insert said square aperture section said flush with said outside said face of said housing ratchet side; said upmost portion of said square said aperture comprising said cylindrical said step; said bottommost portion of said step is said upmost portion of said circumferential said flange; said circumferential said flange said projects orthogonnally from said smooth cylindrical outer surface surrounding said square said aperture; said upmost portion of said cylindrical said step is said upmost portion of said ratchet insert said square said aperture; said bottommost portion of said cylindrical said step is said upmost portion of said circumferential said flange; said thickness of said cylindrical said step is of said greater said thickness in relation to said thickness of said housing ratchet side to permit said adequate free said movement of said parts relative to each other; said outside said diameter of said step are said clearance said fit in said circular said aperture of said housing ratchet side and are of said identical said outside said diameter of said outside diameter of said smooth said cylindrical said outer said surface upon said opposite said section of said ratchet insert; said opposite section of said ratchet insert comprising said smooth said cylindrical said outer said surface; said smooth said cylindrical said outer said surface said begins at said bottommost portion of said circumferential flange and surrounds said entire said smooth said cylindrical said outer said surface to be said interference fit into said gear; said smooth said cylindrical said outer said surface said formed to be said interference said fit said against said inner said diameter of said larger said diameter said cylindrical said bore in said center gear; said ratchet insert said interference said fit said securely into said center of said external center gear by said interference said fit said method; said smooth said cylindrical said outer said surface section upon said ratchet insert and said socket insert said interference said fit into said gears up to said bottommost portion of said circumferential said flange; said bottommost portion of said any said circumferential said flange rests upon said upmost said portion of said larger said diameter orthogonal said outer said member comprised said smooth said cylindrical said outer said surface upon said gear; said ratchet insert said concentric with said circular said apertures within said fully said assembled said Dual Ratchet Mechanism; said ratchet insert said concentric with said gear; said ratchet insert said concentric with said cylindrical orthogonal said hub said upon said interior of said housing ratchet side; said ratchet insert and said gear said rotate as one; are a said permanently said secured said unit; and said rotate said bi-directionally; said socket insert said concentric with said circular said aperture within said fully said assembled said Dual Ratchet Mechanism; said socket insert said concentric with said gear; said socket insert said concentric with said cylindrical orthogonal said hub upon said interior of said housing socket side; said socket insert and said gear will rotate as one; are a said permanently said secured said unit; and said rotate said bi-directionally; said triaxially said engaging said gear said sequence a said means said within said dual Ratchet Mechanism said apparatus for said conveying rotation of said ratchet insert to said socket inserts comprising said three said alike said gears said engaged said triaxially with said equal said outside said diameter; and said equal said root said diameter; and said equal said center said distances; said gears have said alike said number of said teeth; said alike said circular said tooth said thickness; and said alike said chordal said tooth said thickness; all said gear said teeth said angled said alike at said tooth said flank; tooth land of said gear said teeth said seated in said whole said depth of said gear and said project with said minimum said clearance said between said tooth land and said root said diameter of said gear said tooth; said gear said teeth said circumferentially said surround said gears; in said relation to said center said gear two said interlocking said external said idler said gears said disposed at an said angle with said respect to the said center said gear to said provide one said impulse per said revolution; said gears are of said proper said tensile said strength and said durability and said endure said torque transfer said through said Dual Ratchet Mechanism; said upon said one said side of said each said gear said flat said outer said surface said of said each said gear and said perpendicular to said axis of said each said gear is said any orthogonal said outer said member said comprised said smooth said cylindrical said outer said surface; said orthogonal said outer said member said comprised said smooth said cylindrical said outer said surface said projects said orthogonnally from said center of said each said gear said thickness; upon said opposite side of each said gear said flat said outer said surface of said each said gear and said perpendicular to said axis of said each said gear is said another orthogonal said outer said member comprised said smooth said cylindrical said outer said surface; one orthogonal outer said member said comprised said smooth said cylindrical said outer said surface said having said larger said diameter said smooth said cylindrical said outer said surface than said opposite said side orthogonal said outer said member said comprised said smooth said cylindrical said outer said surface; said larger said diameter said smooth said cylindrical said outer said surface comprising said cylindrical bore in said center of said smooth said cylindrical said outer said surface; said cylindrical bore comprising said internal said smooth said surface said surrounding said internal surface of said cylindrical bore; said center of said cylindrical bore in said center of said smooth said cylindrical said outer said surface is said radial said distance of said gear; said cylindrical bore said stops at said center of said total said thickness of said gear and said cylindrical bore of said lesser said diameter said continues said from said there and said extends therethrough to said upmost said portion of said lesser said diameter orthogonal said outer said member comprised said smooth said cylindrical said outer said surface; said lesser said diameter said cylindrical bore is centered in said larger said diameter said cylindrical bore; said larger said diameter orthogonal outer said member comprised said smooth said cylindrical said outer said surface of said gear is said larger said diameter of said cylindrical bores; said ratchet and said socket insert are said interference said fit into said larger said diameter said cylindrical bore of each said gear; said larger diameter orthogonal said outer said member comprised said smooth said cylindrical said outer said surface upon said gear are of said ample size to said allow said sufficient said thickness of said material said around said ratchet and said socket insert said smooth said cylindrical said outer said surfaces; said lesser said diameter said cylindrical said bore in said lesser said diameter orthogonal said outer said member said comprised said smooth said cylindrical said outer said surface of each said gear is said rotatably said mounted said upon said cylindrical orthogonal said hub said mentioned in said aforementioned said housing said explanation; said cylindrical bore comprising said internal said smooth said surface said surrounding said interior surface of said bore; said lesser orthogonal said outer said member said are of said ample said size to said allow for said sufficient said thickness of said material around said hub; in said center said gear in said triaxially said engaged said gear said sequence said ratchet insert said smooth said cylindrical said outer said surface is said interference fit into said larger of said cylindrical bores in said gear; said lesser said diameter said cylindrical bore of said center said gear is said rotatably said mounted upon said cylindrical orthogonal said hub upon said housing socket side; in said each said external said idler said gears said socket inserts are said interference said fit into said larger said diameter said cylindrical bores in said gear; said lesser said diameter said cylindrical bore in said external said idler said gears said rotatably said mount upon said cylindrical said orthogonal said hubs said housing ratchet side; said gears are of said proper said tensile said strength and said durability and said endure said torque said transfer said through said Dual Ratchet Mechanism.

5. Dual Ratchet Mechanism comprising said ratchet insert said permanently said secured to said universal joint wherein said ratchet insert said permanently said secured to said universal joint; said universal joint comprising said cylindrical said outer said surface comprising said square aperture said interior of said cylindrical said outer said surface upon one said section for connection with said device; upon said opposite section said universal joint comprising said cylindrical said outer said surface comprising said output stud said projecting orthogonnally said beyond said cylindrical said outer said surface for operative connection with permanently secured device; said universal joint said intermediate said section comprising said bi-directional said joint; said universal joint comprising said two said separate said members; one said section of said member comprising said square said aperture said interior of said cylindrical said outer said surface; said opposite said section of said separate said member comprising said two said outer said members said projecting orthogonnally said beyond said upmost portion said interconnecting with said two said outer members said projecting orthogonnally said beyond said opposite said section said upmost portion; said opposite said section comprising said square said aperture said interior of said cylindrical said outer said surface; said opposite section of said separate said member comprising said two said outer said members said project orthogonal said beyond said upmost portion of said cylindrical said outer said surface; said outer members comprising said operative said joint connection wherein said outer said members said project orthogonal said beyond said upmost potion of said cylindrical said outer said surface; said outer member said correspondingly said fit said interior of said opposite said members; said each said outer said member comprising said identical said corresponding said cylindrical bore said therethrough for said separate said cylindrical said member relational correspondence; said cylindrical said member allows all said members said operative said bi-directional said motion while said securing said outer said members from said disconnection; said cylindrical bore said parallel with said bottommost portion of said square said aperture; said cylindrical said member said parallel with said bottommost portion of said square said aperture; said outer said members said project orthogonnally said distance allowing for said sufficient clearance of said relative parts for said workable said use; said universal joint comprising said durability of said material said utilized to said form said universal joint to said withstand said torque said transfer from said fully assembled said Dual Ratchet Mechanism through said universal joint and to said threaded said securing said device; said universal joint moves bi-directionally and allows for operative use with said fully said assembled said Dual Ratchet Mechanism.

6. Dual Ratchet Mechanism in accordance with claim 4 comprising said any housing ratchet side comprising said any convex surface wherein said any housing ratchet side comprising said any convex surface; said any interior surface of said any housing ratchet side is convex; exterior surface of said any housing ratchet side is convex; including said any combination of said any convex said any housing ratchet side; including flange surface areas aid any convex comprising said any curved form; including said any housing ratchet side comprising said any permanently secured said any self-powered device; including said any housing ratchet side comprising said any permanently secured said any orthogonal self-powered device; including said any housing ratchet side comprising said any permanently secured said any angular self-powered device; including said any housing ratchet side comprising said any permanently secured said any self-powered device; including said any housing socket side comprising said any self-powered device formed as part of said any housing socket side in any manner; including said any housing ratchet side said any permanently secured comprising said any interchangeable said any device; including said any housing ratchet side said any temporarily secured comprising said any interchangeable said any device; including said any housing ratchet side said any formed as part of said any interchangeable said any device; including said any housing ratchet side comprising said any temporarily secured said any device; including said any housing ratchet side comprising said any temporarily secured said any clamping device; including said any housing ratchet side comprising said any temporarily secured said any clamping device; including said any self-forming socket said any permanently secured to said any housing ratchet side; including said any self-forming socket adaptor said any permanently secured to said any housing ratchet side; including said any extension adaptor said any permanently secured to said any ratchet insert; including said any extension adaptor said any permanently secured to said any aperture upon said any ratchet insert; including said threadably mountable member said any permanently secured to said any housing ratchet side; including said threadably mountable member adaptor said any permanently secured to said any housing ratchet side; including said any battery compelled device said any permanently secured to said any ratchet insert; including said any battery compelled device said any permanently secured to said any aperture within said any ratchet insert; including said any battery compelled device adaptor said any permanently secured to said any ratchet insert; including said any battery compelled device adaptor said any permanently secured to said any aperture within said any ratchet insert; including said any fully assembled said any Dual Ratchet Mechanism comprising said any permanently secured said any self-powered device; including said any fully assembled said any Dual Ratchet Mechanism comprising said any permanently secured said any orthogonal self powered device; including said any fully assembled said any Dual Ratchet Mechanism comprising said any permanently secured said any angular self powered device; including said any frilly assembled said any Dual Ratchet Mechanism comprising said any temporarily secured said any self-powered device; including said any fully assembled said any Dual Ratchet Mechanism comprising said any self-powered device formed as part of said any ratchet insert in any manner; including said any fully assembled said any Dual Ratchet Mechanism said any permanently secured comprising said any interchangeable said any device; including said any fully assembled said any Dual Ratchet Mechanism said any temporarily secured comprising said any interchangeable said any device; including said any fully assembled said any Dual Ratchet Mechanism said any formed as part of comprising said any interchangeable said any device; including said any fully assembled said any Dual Ratchet Mechanism comprising said any temporarily secured any device; including said any fully assembled said any Dual Ratchet Mechanism comprising said any temporarily secured said any clamping device; including said any fully assembled said any Dual Ratchet Mechanism formed as part of said any clamping device; including said any permanently secured said any electrically compelled device said any permanently secured to said any fully assembled said any Dual Ratchet Mechanism; including said any fully assembled said any Dual Ratchet Mechanism comprising said any permanently secured said any ratcheting device; including said any socket of greater depth said any permanently secured to said any fully assembled said any Dual Ratchet Mechanism; including said any socket of greater depth adaptor said any permanently secured to said any fully assembled said any Dual Ratchet Mechanism; including said any shaft said any permanently secured to said any fully assembled said any Dual Ratchet Mechanism; including said any shaft adaptor said any permanently secured to said any fully assembled said any Dual Ratchet Mechanism; including said any self-forming socket said any permanently secured to said any fully assembled said any Dual Ratchet Mechanism; including said any self-forming socket adaptor said any permanently secured to said any fully assembled said any Dual Ratchet Mechanism; including said any coupling structure adaptor said any permanently secured to said any fully assembled said any Dual Ratchet Mechanism; including said any battery powered device said any permanently secured to said any fully assembled said any Dual Ratchet Mechanism; including said any battery powered device adaptor said any permanently secured to said any fully assembled said any Dual Ratchet Mechanism; including said any threaded securing device said any permanently secured to said any fully assembled said any Dual Ratchet Mechanism; including said any threaded securing device adaptor said any permanently secured to said any fully assembled said any Dual Ratchet Mechanism; including said any dual universal swivel adaptor said any permanently secured to said any fully assembled said any Dual Ratchet Mechanism; including said any dual universal joint adaptor said any permanently secured to said any fully assembled said any Dual Ratchet Mechanism; including said permanently secured said any rotary accessory device adaptor said any permanently secured to said any fully assembled said any Dual Ratchet Mechanism; including said any threadably mountable member permanently secured to said any fully assembled said any Dual Ratchet Mechanism; including said any threadably mountable member adaptor said any permanently secured to said any fully assembled said any Dual Ratchet Mechanism; including said any hex formed said any output stud permanently secured to said any fully assembled said any Dual Ratchet Mechanism; including said any hex formed said any output stud adaptor said any permanently secured to said any fully assembled said any Dual Ratchet Mechanism; including said any internal hollow in one part that receives any other corresponding part adaptor said any permanently secured to said any fully assembled said any Dual Ratchet Mechanism; including said any battery compelled device said any permanently secured to said any fully assembled said any Dual Ratchet Mechanism; including said any battery compelled device adaptor said any permanently secured to said any fully assembled said any Dual Ratchet Mechanism; including said any means said any permanently secured to said any fully assembled said any Dual Ratchet Mechanism; including said any means adaptor said any permanently secured to said any fully assembled said any Dual Ratchet Mechanism; including said any torque transmitting device said any permanently secured to said any fully assembled said any Dual Ratchet Mechanism; including said any torque transmitting device adaptor said any permanently secured to said any fully assembled said any Dual Ratchet Mechanism; including said any pneumatic compelled device said any permanently secured to said any fully assembled said any Dual Ratchet Mechanism; including said any pneumatic compelled device adaptor said any permanently secured to said any fully assembled said any Dual Ratchet Mechanism; including said any interchangeable compelling device adaptor said any permanently secured to said any ratchet insert; including said any interchangeable compelling device adaptor said any permanently secured to said any aperture within said any ratchet insert; including said any interchangeable compelling device said any permanently secured to said any fully assembled said any Dual Ratchet Mechanism; including said any interchangeable compelling device adaptor said any permanently secured to said any fully assembled said any Dual Ratchet Mechanism; including said any form internal aperture said any permanently secured to said any fully assembled said any Dual Ratchet Mechanism; including said any form internal aperture adaptor said any permanently secured to said any fully assembled said any Dual Ratchet Mechanism; including said any compelling device said any permanently secured to said any fully assembled said any Dual Ratchet Mechanism; including said any compelling device adaptor said any permanently secured to said any fully assembled said any Dual Ratchet Mechanism; including said any socket said any permanently secured to said any fully assembled said any Dual Ratchet Mechanism; including said any socket adaptor said any permanently secured to said any fully assembled said any Dual Ratchet Mechanism; said any housing ratchet side comprising said any convex surface allows said any housing ratchet side and said any housing socket side to be a permanently secured unit; allows said any Dual Ratchet Mechanism to rotate; to rotate bi-directionally and to allow said any Dual Ratchet Mechanism to work correctly as stated in the aforementioned claim 1.

7. Dual Ratchet Mechanism in accordance with claim 4 comprising said any housing ratchet side produced from said any substance wherein said any housing ratchet side produced from said any substance; said any housing ratchet side said any hub produced from said any substance; said any orthogonal flange produced from said any substance; said any housing ratchet side produced from said any material workable comprising Dual Ratchet Mechanism; including said any light alloy; including said any aluminum; including said any alloy; including said any composite; including said any permanently secured handle; including said any device said any permanently secured to said any housing ratchet side produced from said any substance; including said any housing ratchet side comprising said any permanently secured said any self-powered device; including said any housing ratchet side comprising said any permanently secured said any orthogonal self-powered device; including said any housing ratchet side comprising said any permanently secured said any angular self-powered device; including said any housing ratchet side comprising said any permanently secured said any self-powered device; including said any housing socket side comprising said any self-powered device formed as part of said any housing socket side in any manner; including said any housing ratchet side said any permanently secured comprising said any interchangeable said any device; including said any housing ratchet side said any temporarily secured comprising said any interchangeable said any device; including said any housing ratchet side said any formed as part of said any interchangeable said any device; including said any housing ratchet side comprising said any temporarily secured said any device; including said any housing ratchet side comprising said any temporarily secured said any clamping device; including said any housing ratchet side comprising said any temporarily secured said any clamping device; including said any self-forming socket said any permanently secured to said any housing ratchet side; including said any self-forming socket adaptor said any permanently secured to said any housing ratchet side; including said any extension adaptor said any permanently secured to said any ratchet insert; including said any extension adaptor said any permanently secured to said any aperture upon said any ratchet insert; including said threadably mountable member said any permanently secured to said any housing ratchet side; including said threadably mountable member adaptor said any permanently secured to said any housing ratchet side; including said any battery compelled device said any permanently secured to said any ratchet insert; including said any battery compelled device said any permanently secured to said any aperture within said any ratchet insert; including said any battery compelled device adaptor said any permanently secured to said any ratchet insert; including said any battery compelled device adaptor said any permanently secured to said any aperture within said any ratchet insert; including said any fully assembled said any Dual Ratchet Mechanism comprising said any permanently secured said any self-powered device; including said any fully assembled said any Dual Ratchet Mechanism comprising said any permanently secured said any orthogonal self powered device; including said any fully assembled said any Dual Ratchet Mechanism comprising said any permanently secured said any angular self powered device; including said any fully assembled said any Dual Ratchet Mechanism comprising said any temporarily secured said any self-powered device; including said any fully assembled said any Dual Ratchet Mechanism comprising said any self-powered device formed as part of said any ratchet insert in any manner; including said any fully assembled said any Dual Ratchet Mechanism said any permanently secured comprising said any interchangeable said any device; including said any fully assembled said any Dual Ratchet Mechanism said any temporarily secured comprising said any interchangeable said any device; including said any fully assembled said any Dual Ratchet Mechanism said any formed as part of comprising said any interchangeable said any device; including said any fully assembled said any Dual Ratchet Mechanism comprising said any temporarily secured any device; including said any fully assembled said any Dual Ratchet Mechanism comprising said any temporarily secured said any clamping device; including said any fully assembled said any Dual Ratchet Mechanism formed as part of said any clamping device; including said any permanently secured said any electrically compelled device said any permanently secured to said any fully assembled said any Dual Ratchet Mechanism; including said any fully assembled said any Dual Ratchet Mechanism comprising said any permanently secured said any ratcheting device; including said any socket of greater depth said any permanently secured to said any fully assembled said any Dual Ratchet Mechanism; including said any socket of greater depth adaptor said any permanently secured to said any fully assembled said any Dual Ratchet Mechanism; including said any shaft said any permanently secured to said any fully assembled said any Dual Ratchet Mechanism; including said any shaft adaptor said any permanently secured to said any fully assembled said any Dual Ratchet Mechanism; including said any self-forming socket said any permanently secured to said any fully assembled said any Dual Ratchet Mechanism; including said any self-forming socket adaptor said any permanently secured to said any fully assembled said any Dual Ratchet Mechanism; including said any coupling structure adaptor said any permanently secured to said any fully assembled said any Dual Ratchet Mechanism; including said any battery powered device said any permanently secured to said any fully assembled said any Dual Ratchet Mechanism; including said any battery powered device adaptor said any permanently secured to said any fully assembled said any Dual Ratchet Mechanism; including said any threaded securing device said any permanently secured to said any fully assembled said any Dual Ratchet Mechanism; including said any threaded securing device adaptor said any permanently secured to said any fully assembled said any Dual Ratchet Mechanism; including said any dual universal swivel adaptor said any permanently secured to said any fully assembled said any Dual Ratchet Mechanism; including said any dual universal joint adaptor said any permanently secured to said any fully assembled said any Dual Ratchet Mechanism; including said permanently secured said any rotary accessory device adaptor said any permanently secured to said any fully assembled said any Dual Ratchet Mechanism; including said any threadably mountable member permanently secured to said any fully assembled said any Dual Ratchet Mechanism; including said any threadably mountable member adaptor said any permanently secured to said any fully assembled said any Dual Ratchet Mechanism; including said any hex formed said any output stud permanently secured to said any fully assembled said any Dual Ratchet Mechanism; including said any hex formed said any output stud adaptor said any permanently secured to said any fully assembled said any Dual Ratchet Mechanism; including said any internal hollow in one part that receives any other corresponding part adaptor said any permanently secured to said any fully assembled said any Dual Ratchet Mechanism; including said any battery compelled device said any permanently secured to said any fully assembled said any Dual Ratchet Mechanism; including said any battery compelled device adaptor said any permanently secured to said any fully assembled said any Dual Ratchet Mechanism; including said any means said any permanently secured to said any fully assembled said any Dual Ratchet Mechanism; including said any means adaptor said any permanently secured to said any fully assembled said any Dual Ratchet Mechanism; including said any torque transmitting device said any permanently secured to said any fully assembled said any Dual Ratchet Mechanism; including said any torque transmitting device adaptor said any permanently secured to said any fully assembled said any Dual Ratchet Mechanism; including said any pneumatic compelled device said any permanently secured to said any fully assembled said any Dual Ratchet Mechanism; including said any pneumatic compelled device adaptor said any permanently secured to said any fully assembled said any Dual Ratchet Mechanism; including said any interchangeable compelling device adaptor said any permanently secured to said any ratchet insert; including said any interchangeable compelling device adaptor said any permanently secured to said any aperture within said any ratchet insert; including said any interchangeable compelling device said any permanently secured to said any fully assembled said any Dual Ratchet Mechanism; including said any interchangeable compelling device adaptor said any permanently secured to said any fully assembled said any Dual Ratchet Mechanism; including said any form internal aperture said any permanently secured to said any fully assembled said any Dual Ratchet Mechanism; including said any form internal aperture adaptor said any permanently secured to said any fully assembled said any Dual Ratchet Mechanism; including said any compelling device said any permanently secured to said any fully assembled said any Dual Ratchet Mechanism; including said any compelling device adaptor said any permanently secured to said any fully assembled said any Dual Ratchet Mechanism; including said any socket said any permanently secured to said any fully assembled said any Dual Ratchet Mechanism; including said any socket adaptor said any permanently secured to said any fully assembled said any Dual Ratchet Mechanism; said any housing ratchet side produced from said any substance thus allowing said any Dual Ratchet Mechanism to rotate bi-directionally and to allow said any Dual Ratchet Mechanism to work correctly as stated in the aforementioned claim 4.

8. Dual Ratchet Mechanism in accordance with claim 4 comprising said any ratchet insert comprising said any permanently secured said any ratcheting device wherein said any ratchet insert comprising said any permanently secured said any ratcheting device; said any permanently secured said any ratcheting device is said any permanently secured to said any ratchet insert from said any element upon said any permanently secured said any ratcheting device to said any aperture section within said any smooth cylindrical outer surface section opposite from said any smooth cylindrical outer surface section said any interference fit into said any gear and operatively compels said any ratchet insert whereby compelling said any Dual Ratchet Mechanism; including said any element upon said any permanently secured said any ratcheting device formed as part of said any ratchet insert; including said any permanently secured said any ratcheting device formed as part of said any ratchet insert; including said any permanently secured said any ratcheting device said any permanently secured to said any aperture within said any ratchet insert in said any manner; including said any ratchet insert comprising said any permanently secured said any self-powered device; including said any ratchet insert comprising said any permanently secured said any orthogonal self- powered device; including said any ratchet insert comprising said any permanently secured said any angular self-powered device; including said any ratchet insert comprising said any permanently secured said any self-powered device; including said any ratchet insert comprising said any self-powered device formed as part of said any ratchet insert in any manner; including said any permanently secured said any ratchet insert comprising said any permanently secured said any element upon said any torque transmitting gun; including said any permanently secured said any ratchet insert comprising said any temporarily secured said any element upon said any torque transmitting gun; including said any permanently secured said any ratchet insert formed as part of said any element upon said any torque transmitting gun; including said any permanently secured said any ratchet insert comprising said any permanently secured said any element upon said any torque transmitting device; including said any permanently secured said any ratchet insert comprising said any temporarily secured said any element upon said any torque transmitting device; including said any permanently secured said any ratchet insert formed as part of said any element upon said any torque transmitting device; including said any ratchet insert comprising said any permanently secured said any form extension; including said any ratchet insert comprising said any temporarily secured said any form extension; including said any ratchet insert formed as part of said any form extension; including said any ratchet insert said any permanently secured comprising said any interchangeable said any device; including said any ratchet insert said any temporarily secured comprising said any interchangeable said any device; including said any ratchet insert said any formed as part of said any interchangeable said any device; including said any ratchet insert comprising said any temporarily secured said any device; including said any ratchet insert comprising said any temporarily secured said any clamping device; including said any ratchet insert formed as part of said any clamping device; including said any ratchet insert said any rotatably mounted upon said any angular hub comprising said any permanently secured said any bearing; including said any ratchet insert said any rotatably mounted upon said any orthogonal hub said any permanently secured comprising said any bearing; including said any ratchet insert said any rotatably mounted upon said any form orthogonal hub comprising said any permanently secured said any bearing; including said any ratchet insert said any rotatably mounted upon said any form angular hub comprising said any permanently secured said any bearing; including said any ratchet insert comprising said any bearing said any rotatably mounted upon said any form orthogonal hub; including said any ratchet insert comprising said any permanently secured said any bearing said any rotatably mounted upon said any form said any angular hub; including said any permanently secured bearing said any permanently secured to said any ratchet insert; including said any ratchet insert said any rotatably mounted upon said any orthogonal hub of said any greater length; including said any ratchet insert said any rotatably mounted upon said any orthogonal hub of said any greater length comprising said any bearing; including said any ratchet insert said any rotatably mounted upon said any angular hub of said any greater length; including said any ratchet insert said any rotatably mounted upon said any angular hub of said any greater length comprising said any bearing; including said any ratchet insert said any rotatably mounted upon said any form hub of said any greater length; including said any ratchet insert said any rotatably mounted upon said any form hub of said any greater length comprising said any bearing; including said any ratchet insert said any rotatably mounted upon said any hub of said any greater length; including said any ratchet insert said any rotatably mounted upon said any hub of said any greater length comprising said any bearing; including said any permanently secured said any electrically compelled device said any permanently secured to said any ratchet insert; including said any ratchet insert comprising said any permanently secured said any ratcheting device; including said any socket of greater depth said any permanently secured to said any ratchet insert; including said any socket of greater depth adaptor said any permanently secured to said any ratchet insert; including said any shaft said any permanently secured to said any aperture upon said any ratchet insert; including said any shaft said any permanently secured to said any ratchet insert; including said any shaft adaptor said any permanently secured to said any aperture within said any ratchet insert; including said any shaft adaptor said any permanently secured to said any ratchet insert; including said any self-forming socket said any permanently secured to said any aperture within said any ratchet insert; including said any self-forming socket adaptor said any permanently secured to said any aperture within said any ratchet insert; including said any self-forming socket said any permanently secured to said any ratchet insert; including said any self-forming socket adaptor said any permanently secured to said any ratchet insert; including said any coupling structure said any permanently secured to said any ratchet insert; including said any coupling structure adaptor said any permanently secured to said any ratchet insert; including said any battery powered device said any permanently secured to said any aperture within said ratchet insert; including said any battery powered device adaptor said any permanently secured to said any aperture within said ratchet insert; including said any battery powered device said any permanently secured to said any ratchet insert; including said any battery powered device adaptor said any permanently secured to said ratchet insert; including said any extension said any permanently secured to said any universal swivel; including said any extension adaptor said any permanently secured to said any universal swivel; including said any extension said any permanently secured to said any universal swivel adaptor; including said any extension adaptor said any permanently secured to said any universal swivel adaptor; including said threaded securing device said any permanently secured to said any ratchet insert; including said threaded securing device adaptor said any permanently secured to said any ratchet insert; including said threaded securing device said any permanently secured to said any output stud upon said ratchet insert; including said threaded securing device adaptor said any permanently secured to said any output stud upon said ratchet insert; including said Dual universal swivel adaptor said any permanently secured to said any ratchet insert; including said Dual universal swivel adaptor said any permanently secured to said any aperture within said any ratchet insert; including said Dual universal joint adaptor said any permanently secured to said any ratchet insert; including said Dual universal joint adaptor said any permanently secured to said any aperture within said any ratchet insert; including said any hex formed said any output stud said any permanently secured to said any ratchet insert; including said any hex formed said any output stud adaptor said any permanently secured to said any ratchet insert; including said any hex formed said any output stud adaptor said any permanently secured to said any aperture within said any ratchet insert; including said any internal hollow in one part that receives any other corresponding part adaptor said any permanently secured to said any ratchet insert; including said any means said any permanently secured to said any ratchet insert; including said any means said any permanently secured to said any aperture within said any ratchet insert; including said any means adaptor said any permanently secured to said any ratchet insert; including said any means adaptor said any permanently secured to said any aperture within said any ratchet insert; including said any torque transmitting device said any permanently secured to said any ratchet insert; including said any torque transmitting device said any permanently secured to said any aperture within said any ratchet insert; including said any torque transmitting device adaptor said any permanently secured to said any ratchet insert; including said any torque transmitting device adaptor said any permanently secured to said any aperture within said any ratchet insert; including said any torque transmitting device adaptor said any permanently secured to said any output stud upon said any ratchet insert; including said any battery compelled device said any permanently secured to said any ratchet insert; including said any battery compelled device said any permanently secured to said any aperture within said any ratchet insert; including said any battery compelled device adaptor said any permanently secured to said any ratchet insert; including said any battery compelled device adaptor said any permanently secured to said any aperture within said any ratchet insert; including said any pneumatic compelled device said any permanently secured to said any ratchet insert; including said any pneumatic compelled device said any permanently secured to said any aperture within said any ratchet insert; including said any pneumatic compelled device adaptor said any permanently secured to said any ratchet insert; including said any pneumatic compelled device adaptor said any permanently secured to said any aperture within said any ratchet insert; including said any socket adaptor said any permanently secured to said any ratchet insert; including said any socket adaptor said any permanently secured to said any aperture within said any ratchet insert; including said any length said any ratchet insert projecting said any outwardly orthogonnally beyond said any outside face of said housing ratchet side; including said any length said any ratchet insert projecting said any outwardly angularly beyond said any outside face of said housing ratchet side; including said any socket insert comprising said any permanently secured said any self-powered device; including said any socket insert comprising said any permanently secured said any orthogonal self-powered device; including said any socket insert comprising said any permanently secured said any angular self-powered device; including said any socket insert comprising said any temporarily secured said any self-powered device; including said any socket insert comprising said any self-powered device formed as part of said any ratchet insert in any manner; including said any permanently secured said any socket insert comprising said any permanently secured said any element upon said any torque transmitting gun; including said any permanently secured said any socket insert comprising said any temporarily secured said any element upon said any torque transmitting gun; including said any permanently secured said any socket insert formed as part of said any element upon said any torque transmitting gun; including said any permanently secured said any socket insert comprising said any permanently secured said any element upon said any torque transmitting device; including said any permanently secured said any socket insert comprising said any temporarily secured said any element upon said any torque transmitting device; including said any permanently secured said any socket insert formed as part of said any element upon said any torque transmitting device; including said any socket insert comprising said any permanently secured said any form extension; including said any socket insert comprising said any temporarily secured said any form extension; including said any socket insert formed as part of said any form extension; including said any socket insert said any permanently secured comprising said any interchangeable said any device; including said any socket insert said any temporarily secured comprising said any interchangeable said any device; including said any socket insert said any formed as part of said any interchangeable said any device; including said any socket insert comprising said any temporarily secured said any device; including said any socket insert comprising said any temporarily secured said any clamping device; including said any socket insert formed as part of said any clamping device; including said any socket insert said any rotatably mounted upon said any angular hub comprising said any permanently secured said any bearing; including said any socket insert said any rotatably mounted upon said any orthogonal hub comprising said any permanently secured said any bearing; including said any socket insert said any rotatably mounted upon said any form orthogonal hub comprising said any permanently secured said any bearing; including said any socket insert said any rotatably mounted upon said any form angular hub comprising said any permanently secured said any bearing; including said any socket insert comprising said any bearing said any rotatably mounted upon said any form orthogonal hub; including said any socket insert comprising said any permanently secured said any bearing said any rotatably mounted upon said any form said any angular hub; including said any permanently secured bearing said any permanently secured to said any socket insert; including said any socket insert said any rotatably mounted upon said any orthogonal hub of said any greater length; including said any socket insert said any rotatably mounted upon said any orthogonal hub of said any greater length comprising said any bearing; including said any socket insert said any rotatably mounted upon said any angular hub of said any greater length; including said any socket insert said any rotatably mounted upon said any angular hub of said any greater length comprising said any bearing; including said any socket insert said any rotatably mounted upon said any form hub of said any greater length; including said any socket insert said any rotatably mounted upon said any form hub of said any greater length comprising said any bearing; including said any socket insert said any rotatably mounted upon said any hub of said any greater length; including said any socket insert said any rotatably mounted upon said any hub of said any greater length comprising said any bearing; including said any output stud projecting said any outwardly any angular in relation to said any outside face of said any fully assembled said any Dual Ratchet Mechanism; including said any socket insert comprising said any permanently secured said any ratcheting device; including said any socket of greater depth said any permanently secured to said any socket insert; including said any socket of greater depth said any permanently secured to said any output stud upon said socket insert; including said any socket of greater depth adaptor said any permanently secured to said any output stud upon said socket insert; including said any shaft said any permanently secured to said any output stud upon said any socket insert; including said any shaft said any permanently secured to said any socket insert; including said any shaft adaptor said any permanently secured to said any output stud upon said any socket insert; including said any shaft adaptor said any permanently secured to said any socket insert; including said any self-forming socket said any permanently secured to said any output stud upon said socket insert; including said any self-forming socket adaptor said any permanently secured to said any output stud upon said socket insert; including said any self-forming socket said any permanently secured to said any socket insert; including said any self-forming socket adaptor said any permanently secured to said any socket insert; including said any coupling structure said any permanently secured to said any socket insert; including said any shackle coupling structure adaptor said any permanently secured to said any socket insert; including said any battery powered device said any permanently secured to said any output stud upon said socket insert; including said any battery powered device adaptor said any permanently secured to said any output stud upon said socket insert; including said any battery powered device said any permanently secured to said any socket insert; including said any battery powered device adaptor said any permanently secured to said any socket insert; including said any extension adaptor said any permanently secured to said any socket insert; including said any extension adaptor said any permanently secured to said any aperture upon said any socket insert; including said any threaded securing device said any permanently secured to said any socket insert; including said threaded securing device adaptor said any permanently secured to said any socket insert; including said threaded securing device said any permanently secured to said any output stud upon said socket insert; including said threaded securing device adaptor said any permanently secured to said any output stud upon said socket insert; including said dual universal swivel adaptor said any permanently secured to said any socket insert; including said dual universal swivel adaptor said any permanently secured to said any output stud upon said any socket insert; including said dual universal joint adaptor said any permanently secured to said any socket insert; including said dual universal joint adaptor said any permanently secured to said any output stud upon said any socket insert; including said any threadably mountable member adaptor said any permanently secured to said any socket insert; including said any hex formed said any output stud permanently secured to said any socket insert; including said any hex formed said any output stud adaptor said any permanently secured to said any socket insert; including said any hex formed said any output stud adaptor said any permanently secured to said any output stud upon said any socket insert; including said any internal hollow in one part that receives any other said any corresponding part adaptor said any permanently secured to said any socket insert; including said any battery compelled device said any permanently secured to said any socket insert; including said any battery compelled device said any permanently secured to said any output stud upon said any socket insert; including said any battery compelled device adaptor said any permanently secured to said any socket insert; including said any battery compelled device adaptor said any permanently secured to said any out put stud upon said any socket insert; including said any means said any permanently secured to said any socket insert; including said any means said any permanently secured to said any out put stud upon said any socket insert; including said any means adaptor said any permanently secured to said any socket insert; including said any means adaptor said any permanently secured to said any out put stud upon said any socket insert; including said any torque transmitting device said any permanently secured to said any socket insert; including said any torque transmitting device said any permanently secured to said any output stud upon said any socket insert; including said any torque transmitting device adaptor said any permanently secured to said any socket insert; including said any torque transmitting device adaptor said any permanently secured to said any output stud upon said any socket insert; including said any pneumatic compelled device said any permanently secured to said any socket insert; including said any pneumatic compelled device said any permanently secured to said any output stud upon said any socket insert; including said any pneumatic compelled device adaptor said any permanently secured to said any socket insert; including said any pneumatic compelled device adaptor said any permanently secured to said any output stud upon said any socket insert; including said any interchangeable compelling device adaptor said any permanently secured to said any socket insert; including said any interchangeable compelling device adaptor said any permanently secured to said any output stud upon said any socket insert; including said any socket adaptor said any permanently secured to said any output stud upon said any gear; including said any socket adaptor said any permanently secured to said any aperture within said any gear; including said any socket adaptor said any permanently secured to said any socket insert; including said any socket adaptor said any permanently secured to said any output stud upon said any socket insert; including said any length said any socket insert projecting said any outwardly orthogonnally beyond said any outside face of said housing socket side; including said any length said any socket insert projecting said any outwardly angularly beyond said any outside face of said housing socket side; including said any socket insert comprising said any permanently secured said any self-powered device; including said any socket insert comprising said any permanently secured said any orthogonal self-powered device; including said any socket insert comprising said any permanently secured said any angular self-powered device; including said any socket insert comprising said any temporarily secured said any self-powered device; including said any socket insert comprising said any self-powered device formed as part of said any socket insert in any manner; including said any fully assembled said any Dual Ratchet Mechanism comprising said any permanently secured said any self-powered device; including said any fully assembled said any Dual Ratchet Mechanism comprising said any permanently secured said any orthogonal self powered device; including said any fully assembled said any Dual Ratchet Mechanism comprising said any permanently secured said any angular self powered device; including said any fully assembled said any Dual Ratchet Mechanism comprising said any temporarily secured said any self-powered device; including said any fully assembled said any Dual Ratchet Mechanism comprising said any self-powered device formed as part of said any ratchet insert in any manner; including said any fully assembled said any Dual Ratchet Mechanism said any permanently secured comprising said any interchangeable said any device; including said any fully assembled said any Dual Ratchet Mechanism said any temporarily secured comprising said any interchangeable said any device; including said any fully assembled said any Dual Ratchet Mechanism said any formed as part of comprising said any interchangeable said any device; including said any fully assembled said any Dual Ratchet Mechanism comprising said any temporarily secured any device; including said any fully assembled said any Dual Ratchet Mechanism comprising said any temporarily secured said any clamping device; including said any fully assembled said any Dual Ratchet Mechanism formed as part of said any clamping device; including said any permanently secured said any electrically compelled device said any permanently secured to said any fully assembled said any Dual Ratchet Mechanism; including said any fully assembled said any Dual Ratchet Mechanism comprising said any permanently secured said any ratcheting device; including said any socket of greater depth said any permanently secured to said any fully assembled said any Dual Ratchet Mechanism; including said any socket of greater depth adaptor said any permanently secured to said any fully assembled said any Dual Ratchet Mechanism; including said any shaft said any permanently secured to said any fully assembled said any Dual Ratchet Mechanism; including said any shaft adaptor said any permanently secured to said any fully assembled said any Dual Ratchet Mechanism; including said any self-forming socket said any permanently secured to said any fully assembled said any Dual Ratchet Mechanism; including said any self-forming socket adaptor said any permanently secured to said any fully assembled said any Dual Ratchet Mechanism; including said any coupling structure adaptor said any permanently secured to said any fully assembled said any Dual Ratchet Mechanism; including said any battery powered device said any permanently secured to said any fully assembled said any Dual Ratchet Mechanism; including said any battery powered device adaptor said any permanently secured to said any fully assembled said any Dual Ratchet Mechanism; including said any threaded securing device said any permanently secured to said any fully assembled said any Dual Ratchet Mechanism; including said any threaded securing device adaptor said any permanently secured to said any fully assembled said any Dual Ratchet Mechanism; including said any dual universal swivel adaptor said any permanently secured to said any frilly assembled said any Dual Ratchet Mechanism; including said any dual universal joint adaptor said any permanently secured to said any fully assembled said any Dual Ratchet Mechanism; including said permanently secured said any rotary accessory device adaptor said any permanently secured to said any fully assembled said any Dual Ratchet Mechanism; including said any threadably mountable member permanently secured to said any fully assembled said any Dual Ratchet Mechanism; including said any threadably mountable member adaptor said any permanently secured to said any fully assembled said any Dual Ratchet Mechanism; including said any hex formed said any output stud permanently secured to said any fully assembled said any Dual Ratchet Mechanism; including said any hex formed said any output stud adaptor said any permanently secured to said any fully assembled said any Dual Ratchet Mechanism; including said any internal hollow in one part that receives any other corresponding part adaptor said any permanently secured to said any fully assembled said any Dual Ratchet Mechanism; including said any battery compelled device said any permanently secured to said any fully assembled said any Dual Ratchet Mechanism; including said any battery compelled device adaptor said any permanently secured to said any fully assembled said any Dual Ratchet Mechanism; including said any means said any permanently secured to said any fully assembled said any Dual Ratchet Mechanism; including said any means adaptor said any permanently secured to said any fully assembled said any Dual Ratchet Mechanism; including said any torque transmitting device said any permanently secured to said any fully assembled said any Dual Ratchet Mechanism; including said any torque transmitting device adaptor said any permanently secured to said any fully assembled said any Dual Ratchet Mechanism; including said any pneumatic compelled device said any permanently secured to said any fully assembled said any Dual Ratchet Mechanism; including said any pneumatic compelled device adaptor said any permanently secured to said any fully assembled said any Dual Ratchet Mechanism; including said any interchangeable compelling device adaptor said any permanently secured to said any ratchet insert; including said any interchangeable compelling device adaptor said any permanently secured to said any aperture within said any ratchet insert; including said any interchangeable compelling device said any permanently secured to said any fully assembled said any Dual Ratchet Mechanism; including said any interchangeable compelling device adaptor said any permanently secured to said any fully assembled said any Dual Ratchet Mechanism; including said any form internal aperture said any permanently secured to said any fully assembled said any Dual Ratchet Mechanism; including said any form internal aperture adaptor said any permanently secured to said any fully assembled said any Dual Ratchet Mechanism; including said any compelling device said any permanently secured to said any fully assembled said any Dual Ratchet Mechanism; including said any compelling device adaptor said any permanently secured to said any fully assembled said any Dual Ratchet Mechanism; including said any socket said any permanently secured to said any fully assembled said any Dual Ratchet Mechanism; including said any socket adaptor said any permanently secured to said any fully assembled said any Dual Ratchet Mechanism; including said any permanently secured bearing comprising said any permanently secured said any self-powered device; including said any permanently secured bearing comprising said any permanently secured said any orthogonal self-powered device; including said any permanently secured bearing comprising said any permanently secured said any angular self-powered device; including said any temporarily secured bearing comprising said any temporarily secured said any self-powered device; including said any bearing comprising said any self- powered device formed as part of said any bearing in any manner; including said any permanently secured said any bearing comprising said any permanently secured said any element upon said any torque transmitting gun; including said any permanently secured said any bearing comprising said any temporarily secured said any element upon said any torque transmitting gun; including said any permanently secured said any bearing formed as part of said any element upon said any torque transmitting gun; including said any permanently secured said any bearing comprising said any permanently secured said any element upon said any torque transmitting device; including said any permanently secured said any bearing comprising said any temporarily secured said any element upon said any torque transmitting device; including said any permanently secured said any socket insert formed as part of said any element upon said any torque transmitting device; including said any bearing comprising said any permanently secured said any form extension; including said any bearing comprising said any temporarily secured said any form extension; including said any bearing formed as part of said any form extension; including said any bearing said any permanently secured comprising said any interchangeable said any device; including said any bearing said any temporarily secured comprising said any interchangeable said any device; including said any bearing said any formed as part of said any interchangeable said any device; including said any permanently secured said any bearing comprising said any temporarily secured said any clamping device; including said any permanently secured said any bearing comprising said any permanently secured said any clamping device; including said any permanently secured said any bearing said any formed as part of said any clamping device; including said any device said any rotatably mounted upon said any angular hub comprising said any permanently secured said any bearing; including said any device said any rotatably mounted upon said any orthogonal hub comprising said any permanently secured said any bearing; including said any device said any rotatably mounted upon said any form orthogonal hub comprising said any permanently secured said any bearing; including said any device said any rotatably mounted upon said any form angular hub comprising said any permanently secured said any bearing; including said any device comprising said any bearing said any rotatably mounted upon said any form orthogonal hub; including said any device comprising said any permanently secured said any bearing said any rotatably mounted upon said any form said any angular hub; including said any permanently secured bearing said any permanently secured to said any permanently secured said any hub; including said any interchangeable bearing said any interchangeable comprising said any orthogonal hub; including said any interchangeable bearing said any interchangeable comprising said any angular hub; including said any interchangeable bearing said any interchangeable comprising said any socket insert; including said any interchangeable bearing said any interchangeable comprising said any ratchet insert; including said any interchangeable bearing said any interchangeable comprising said any housing ratchet side; including said any interchangeable bearing said any interchangeable comprising said any housing socket side; including said any interchangeable bearing said any interchangeable comprising said any permanently secured universal joint; including said any interchangeable bearing said any interchangeable comprising said any permanently secured universal joint adaptor; including said any interchangeable bearing said any interchangeable comprising said any permanently secured universal swivel; including said any interchangeable bearing said any interchangeable comprising said any permanently secured universal swivel adaptor; including said any interchangeable bearing said any interchangeable comprising said any permanently secured extension; including said any interchangeable bearing said any interchangeable comprising said any permanently secured said any device; including said any interchangeable bearing said any interchangeable comprising said any fully assembled said any Dual Ratchet Mechanism; including said any permanently secured said any bearing comprising said any permanently secured said any ratcheting device; including said any permanently secured said any universal joint comprising said any permanently secured said any extension; including said any permanently secured said any universal joint comprising said any permanently secured said any extension adaptor; including said any permanently secured said any universal joint said any permanently secured to said any threadably secured structure; including said any permanently secured said any universal joint said any permanently secured to said any threadably secured structure adaptor; including said any permanently secured said any universal joint comprising said any various supplementary detachable elements; including said any permanently secured said any universal joint comprising said any various supplementary detachable elements adaptor; including said any universal joint comprising said any various supplementary detachable elements comprising said any rotatable said any coupling system incorporated with said any adapted output studs; including said any universal joint comprising said any various supplementary detachable elements adaptor comprising said any rotatable said any coupling system incorporated with said any adapted output studs; including said any permanently secured said any universal joint comprising said any foldable shaft; including said any permanently secured said any universal joint comprising said any foldable shaft adaptor; including said any permanently secured said any universal joint said any permanently secured to said any socket insert comprising said any foldable shaft; including said any permanently secured said any universal joint said any permanently secured to said any socket insert comprising said any foldable shaft adaptor; including said any permanently secured said any universal joint said any permanently secured to said any ratchet insert comprising said any foldable shaft; including said any permanently secured said any universal joint said any permanently secured to said any ratchet insert comprising said any foldable shaft adaptor; including said any permanently secured said any universal joint rotatably mounted upon said any hub of said any greater length; including said any permanently secured said any universal joint altered comprising said any chuck; including said any permanently secured said any universal joint altered comprising said any chuck adaptor; including said any permanently secured said any universal joint altered comprising said any orthogonal chuck projecting said any outwardly orthogonnally in relation to said any universal joint; including said any permanently secured said any universal joint altered comprising said any orthogonal chuck adaptor projecting said any outwardly orthogonnally in relation to said any universal joint; including said any permanently secured said any universal joint altered comprising said any angular chuck projecting said any outwardly said any angularly in relation to said any universal joint; including said any permanently secured said any universal joint altered comprising said any angular chuck adaptor projecting said any outwardly said any angularly in relation to said any universal joint; including said any permanently secured said any universal joint said any permanently secured to said any socket insert said any workably mounted to said any housing ratchet side in said any manner; including said any permanently secured said any universal joint adaptor said any permanently secured to said any socket insert said any workably mounted to said any housing ratchet side in said any manner; including said any permanently secured said any universal joint said any permanently secured to said any fully assembled said any Dual Ratchet Mechanism wherein said any housing socket side and said any housing ratchet side are joined together in said any manner; including said any permanently secured said any universal joint adaptor said any permanently secured to said any fully assembled said any Dual Ratchet Mechanism wherein said any housing socket side and said any housing ratchet side are joined together in said any manner; including said any permanently secured said any universal joint said any permanently secured to said any fully assembled said any Dual Ratchet Mechanism comprising said any convex outer surface; including said any permanently secured said any universal joint adaptor said any permanently secured to said any fully assembled said any Dual Ratchet Mechanism comprising said any convex outer surface; including said any permanently secured said any universal joint said any permanently secured to said any fully assembled said any Dual Ratchet Mechanism wherein said any housing socket side and said housing ratchet side are joined together comprising the use of said any interlocking said any joint; including said any permanently secured said any universal joint adaptor said any permanently secured to said any fully assembled said any Dual Ratchet Mechanism wherein said any housing socket side and said housing ratchet side are joined together comprising the use of said any interlocking said any joint; including said any permanently secured said any universal joint said any permanently secured to said any fully assembled said any Dual Ratchet Mechanism comprising said any gear utilized for said triaxial gear arrangement; including said any permanently secured said any universal joint adaptor said any permanently secured to said any fully assembled said any Dual Ratchet Mechanism comprising said any gear utilized for said triaxial gear arrangement; including said any permanently secured said any universal joint said any permanently secured to said any fully assembled said any Dual Ratchet Mechanism comprising said any stop; including said any permanently secured said any universal joint adaptor said any permanently secured to said any fully assembled said any Dual Ratchet Mechanism comprising said any stop; including said any permanently secured said any universal joint rotatably mounted to said any form said any orthogonal hub upon said any housing socket side; including said any permanently secured said any universal joint adaptor rotatably mounted to said any form said any orthogonal hub upon said any housing socket side; including said any permanently secured said any universal joint rotatably mounted to said any form said any orthogonal hub upon said any housing ratchet side; including said any permanently secured said any universal joint adaptor rotatably mounted to said any form said any orthogonal hub upon said any housing ratchet side; including said any permanently secured said any universal joint said any permanently secured to said any fully assembled said any Dual Ratchet Mechanism comprising said any number of said any detachable said any legs said any temporarily secured; including said any permanently secured said any universal joint adaptor said any permanently secured to said any fully assembled said any Dual Ratchet Mechanism comprising said any number of said any detachable said any legs said any temporarily secured; including said any permanently secured said any universal joint said any permanently secured to said any Dual Ratchet Mechanism comprising said any components produced from said any substance; including said any permanently secured said any universal joint adaptor said any permanently secured to said any Dual Ratchet Mechanism comprising said any components produced from said any substance; including said any permanently secured said any universal joint; comprising said any components produced from said any substance; including said any permanently secured said any universal joint adaptor comprising said any components produced from said any substance; including said any permanently secured said any universal joint said any permanently secured to said any Dual Ratchet Mechanism said any permanently united to said any other said any Dual Ratchet Mechanism; including said any permanently secured said any universal joint adaptor said any permanently secured to said any Dual Ratchet Mechanism said any permanently united to said any other said any Dual Ratchet Mechanism; including said any permanently secured said any universal joint said any permanently secured to said any Dual Ratchet Mechanism said any temporarily united to said any other said any Dual Ratchet Mechanism; including said any permanently secured said any universal joint adaptor said any permanently secured to said any Dual Ratchet Mechanism said any temporarily united to said any other said any Dual Ratchet Mechanism; including said any permanently secured said any universal joint said any permanently secured to said any fully assembled said any Dual Ratchet Mechanism comprising said any substance to form said any permanently secured said any object; including said any permanently secured said any universal joint adaptor said any permanently secured to said any fully assembled said any Dual Ratchet Mechanism comprising said any substance to form said any permanently secured said any object; including said any permanently secured said any universal joint said any permanently secured to said any Dual Ratchet Mechanism comprising said any means for said any temporarily securing said any fully assembled said any Dual Ratchet Mechanism to said any wire rope clip while operatively securing said any wire rope clip to said any wire rope; including said any permanently secured said any universal joint adaptor said any permanently secured to said any Dual Ratchet Mechanism comprising said any means for said any temporarily securing said any fully assembled said any Dual Ratchet Mechanism to said any wire rope clip while operatively securing said any wire rope clip to said any wire rope; including said any permanently secured said any universal joint said any permanently secured to said any Dual Ratchet Mechanism comprising said any means for said any temporarily securing said any fully assembled said any Dual Ratchet Mechanism to said any wire rope while operatively securing said any wire rope clip to said any wire rope; including said any permanently secured said any universal joint adaptor said any permanently secured to said any Dual Ratchet Mechanism comprising said any means for said any temporarily securing said any fully assembled said any Dual Ratchet Mechanism to said any wire rope while operatively securing said any wire rope clip to said any wire rope; including said any permanently secured said any universal joint said any permanently secured to said any Dual Ratchet Mechanism comprising said any housing ratchet side produced from said any substance; including said any permanently secured said any universal joint adaptor said any permanently secured to said any Dual Ratchet Mechanism comprising said any housing ratchet side produced from said any substance; including said any permanently secured said any universal joint said any permanently secured to said any Dual Ratchet Mechanism comprising said any housing socket side produced from said any substance; including said any permanently secured said any universal joint adaptor said any permanently secured to said any Dual Ratchet Mechanism comprising said any housing socket side produced from said any substance; including said any permanently secured said any universal joint said any permanently secured to said any Dual Ratchet Mechanism comprising said any gears produced from said any substance; including said any permanently secured said any universal joint adaptor said any permanently secured to said any Dual Ratchet Mechanism comprising said any gears produced from said any substance; including said any permanently secured said any universal joint said any permanently secured to said any ratchet insert; produced from said any substance; including said any permanently secured said any universal joint adaptor said any permanently secured to said any ratchet insert; produced from said any substance; including said any permanently secured said any universal joint said any permanently secured to said any socket insert produced from said any substance; including said any permanently secured said any universal joint adaptor said any permanently secured to said any socket insert; produced from said any substance; including said any permanently secured said any universal joint said any permanently secured to said any fully assembled said any Dual Ratchet Mechanism comprising said any components said any magnetized; including said any permanently secured said any universal joint adaptor said any permanently secured to said any frilly assembled said any Dual Ratchet Mechanism comprising said any components said any magnetized; including said any permanently secured said any universal joint said any permanently secured to said any socket insert projecting said any outwardly said any angularly beyond said any outside face of said housing socket side; including said any permanently secured said any universal joint adaptor said any permanently secured to said any socket insert projecting said any outwardly said any angularly beyond said any outside face of said housing socket side; including said any permanently secured said any universal joint said any permanently secured to said any socket insert projecting said any outwardly orthogonnally beyond said any outside face of said housing socket side; including said any permanently secured said any universal joint adaptor said any permanently secured to said any socket insert projecting said any outwardly orthogonnally beyond said any outside face of said housing socket side; including said any permanently secured said any universal joint said any permanently secured to said any socket insert descending said any inwardly orthogonnally in relation to said any outside face of said any housing socket side; including said any permanently secured said any universal joint adaptor said any permanently secured to said any socket insert descending said any inwardly orthogonnally in relation to said any outside face of said any housing socket side; including said any permanently secured said any universal joint said any permanently secured to said any socket insert descending said any inwardly said any angularly in relation to said any outside face of said any housing socket side; including said any permanently secured said any universal joint said any permanently adaptor secured to said any socket insert descending said any inwardly said any angularly in relation to said any outside face of said any housing socket side; including said any permanently secured said any universal joint said any permanently secured to said any ratchet insert projecting said any outwardly said any angularly beyond said any outside face of said any housing ratchet side; including said any permanently secured said any universal joint adaptor said any permanently secured to said any ratchet insert projecting said any outwardly said any angularly beyond said any outside face of said any housing ratchet side; including said any permanently secured said any universal joint said any permanently secured to said any ratchet insert projecting said any outwardly orthogonnally beyond said any outside face of said any housing ratchet side; including said any permanently secured said any universal joint adaptor said any permanently secured to said any ratchet insert projecting said any outwardly orthogonnally beyond said any outside face of said any housing ratchet side; including said any permanently secured said any universal joint said any permanently secured to said any ratchet insert descending said any inwardly orthogonnally in relation to said any outside face of said any housing ratchet side; including said any permanently secured said any universal joint adaptor said any permanently secured to said any ratchet insert descending said any inwardly orthogonnally in relation to said any outside face of said any housing ratchet side; including said any permanently secured said any universal joint said any permanently secured to said any ratchet insert descending inwardly said any angularly in relation to said any outside face of said any housing ratchet side; including said any permanently secured said any universal joint adaptor said any permanently secured to said any ratchet insert descending said any inwardly said any angularly in relation to said any outside face of said any housing ratchet side; including said any permanently secured said any universal joint said any permanently secured to said any fully assembled said any Dual Ratchet Mechanism comprising said any alteration; including said any permanently secured said any universal joint adaptor said any permanently secured to said any fully assembled said any Dual Ratchet Mechanism comprising said any alteration; including said any permanently secured said any universal joint said any permanently secured to said any Dual Ratchet Mechanism comprising said any aperture that will operatively connect to said any detent from said any device; including said any permanently secured said any universal joint adaptor said any permanently secured to said any Dual Ratchet Mechanism comprising said any aperture that will operatively connect to said any detent from said any device; including said any permanently secured said any universal joint said any permanently secured to said any fully assembled said any Dual Ratchet Mechanism comprising said any element upon said any torque transmitting gun formed as part of said any ratchet insert; including said any permanently secured said any universal joint adaptor said any permanently secured to said any fully assembled said any Dual Ratchet Mechanism comprising said any element upon said torque transmitting gun formed as part of said any ratchet insert; including said any permanently secured said any universal joint said any permanently secured to said any fully assembled said any Dual Ratchet Mechanism comprising said any element upon said torque transmitting gun formed as part of said any socket insert; including said any permanently secured said any universal joint adaptor said any permanently secured to said any fully assembled said any Dual Ratchet Mechanism comprising said any element upon said any torque transmitting gun formed as part of said any socket insert; including said any permanently secured said any universal joint said any permanently secured to said any square aperture upon said any ratchet insert comprising said any indentation upon said any interior surface of said any square aperture; including said any permanently secured said any universal joint adaptor said any permanently secured to said any square aperture upon said any ratchet insert comprising said any indentation upon said any interior surface of said any square aperture; including said any permanently secured said any universal joint said any permanently secured to said any ratchet insert comprising said any stepped said any internal surface interior of said square aperture; including said any permanently secured said any universal joint adaptor said any permanently secured to said any ratchet insert comprising said any stepped said any internal surface interior of said square aperture; including said any permanently secured said any universal joint said any permanently secured to said any Dual Ratchet Mechanism comprising said any stepped said any internal surface interior of said any square aperture comprising said any number of said any steps; including said any permanently secured said any universal joint adaptor said any permanently secured to said any stepped said any internal surface interior of said any square aperture comprising said any number of said any steps; including said any permanently secured said any universal joint said any permanently secured to said any Dual Ratchet Mechanism comprising said any hollow in one part that receives said any other said any corresponding part formed as part of said any socket insert; including said any permanently secured said any universal joint adaptor said any permanently secured to said any Dual Ratchet Mechanism comprising said any hollow in one part that receives said any other said any corresponding part formed as part of said any socket insert; including said any permanently secured said any universal joint said any permanently secured to said any socket insert comprising said any hollow in one part that receives said any other said any corresponding part projecting said any outwardly orthogonnally beyond said any outside face of said any housing socket side; including said any permanently secured said any universal joint adaptor said any permanently secured to said any socket insert comprising said any hollow in one part that receives said any other said any corresponding part projecting said any outwardly orthogonnally beyond said any outside face of said any housing socket side; including said any permanently secured said any universal joint said any permanently secured to said any socket insert comprising said any hollow in one part that receives said any other said any corresponding part projecting said any outwardly said any angularly beyond said any outside face of said any housing socket side; including said any permanently secured said any universal joint adaptor said any permanently secured to said any socket insert comprising said any hollow in one part that receives said any other said any corresponding part projecting said any outwardly said any angularly beyond said any outside face of said any housing socket side; including said any permanently secured said any universal joint said any permanently secured to said any socket insert comprising said any hollow in one part that receives said any other said any corresponding part descending said any inwardly orthogonnally in relation to said outside face of said any housing socket side; including said any permanently secured said any universal joint adaptor said any permanently secured to said any socket insert comprising said any hollow in one part that receives said any other said any corresponding part descending said any inwardly orthogonnally in relation to said outside face of said any housing socket side; including said any permanently secured said any universal joint said any permanently secured to said any socket insert comprising said any hollow in one part that receives said any other said any corresponding part descending said any inwardly said any angularly in relation to said outside face of said any housing socket side; including said any permanently secured said any universal joint adaptor said any permanently secured to said any socket insert comprising said any hollow in one part that receives said any other said any corresponding part descending said any inwardly said any angularly in relation to said outside face of said any housing socket side; including said any permanently secured said any universal joint said any permanently secured to said any ratchet insert comprising said any hollow in one part that receives said any other said any corresponding part projecting said any outwardly orthogonnally beyond said any outside face of said any housing ratchet side; including said any permanently secured said any universal joint adaptor said any permanently secured to said any ratchet insert comprising said any hollow in one part that receives said any other said any corresponding part projecting said any outwardly orthogonnally beyond said any outside face of said any housing ratchet side; including said any permanently secured said any universal joint said any permanently secured to said any ratchet insert comprising said any hollow in one part that receives said any other said any corresponding part projecting said any outwardly said any angularly beyond said any outside face of said any housing ratchet side; including said any permanently secured said any universal joint adaptor said any permanently secured to said any ratchet insert comprising said any hollow in one part that receives said any other said any corresponding part projecting said any outwardly said any angularly beyond said any outside face of said any housing ratchet side; including said any permanently secured said any universal joint said any permanently secured to said any ratchet insert comprising said any hollow in one part that receives said any other said any corresponding part descending said any inwardly orthogonnally in relation to said outside face of said any housing ratchet side; including said any permanently secured said any universal joint adaptor said any permanently secured to said any ratchet insert comprising said any hollow in one part that receives said any other said any corresponding part descending said any inwardly orthogonnally in relation to said outside face of said any housing ratchet side; including said any permanently secured said any universal joint said any permanently secured to said any ratchet insert comprising said any hollow in one part that receives said any other said any corresponding part descending said any inwardly said any angularly in relation to said outside face of said any housing ratchet side; including said any permanently secured said any universal joint adaptor said any permanently secured to said any ratchet insert comprising said any hollow in one part that receives said any other said any corresponding part descending said any inwardly said any angularly in relation to said outside face of said any housing ratchet side; including said any permanently secured said any universal joint said any permanently secured to said any ratchet insert said any cylindrical step omitted; including said any permanently secured said any universal joint adaptor said any permanently secured to said any ratchet insert said any cylindrical step omitted; including said any permanently secured said any universal joint said any permanently secured to said any socket insert said any cylindrical step omitted; including said any permanently secured said any universal joint adaptor said any permanently secured to said any socket insert said any cylindrical step omitted; including said any permanently secured said any universal joint said any permanently secured to said any ratchet insert said any circumferential flange omitted; including said any permanently secured said any universal joint adaptor said any permanently secured to said any ratchet insert said any circumferential flange omitted; including said any permanently secured said any universal joint said any permanently secured to said any socket insert said any circumferential flange omitted; including said any permanently secured said any universal joint adaptor said any permanently secured to said any socket insert said any circumferential flange omitted; including said any permanently secured said any universal joint comprising said any compelling device said any internal of said any permanently secured said any universal joint; including said any permanently secured said any universal joint adaptor comprising said any compelling device said any internal of said any permanently secured said any universal joint; including said any permanently secured said any universal joint said any permanently secured to said any universal swivel; including said any permanently secured said any universal joint adaptor said any permanently secured to said any universal swivel; including said any permanently secured said any universal joint said any permanently secured to said any universal swivel adaptor; including said any permanently secured said any universal joint adaptor said any permanently secured to said any universal swivel adaptor; including said any permanently secured said any universal joint said any permanently secured to said any interchangeable said any universal swivel; including said any permanently secured said any universal joint adaptor said any permanently secured to said any interchangeable said any universal swivel; including said any permanently secured said any universal joint adaptor said any permanently secured to said interchangeable said any universal swivel adaptor; including said any permanently secured said any universal joint adaptor said any permanently secured to said any interchangeable said any universal swivel adaptor; including said any permanently secured said any universal joint said any permanently secured to said any coupling structure thus interchangeable comprising said any device; including said any permanently secured said any universal joint adaptor said any permanently secured to said any coupling structure thus interchangeable comprising said any device; including said any permanently secured said any universal joint adaptor said any permanently secured to said any coupling structure adaptor thus interchangeable comprising said any device; including said any permanently secured said any universal joint said any permanently secured to said any coupling structure adaptor thus interchangeable comprising said any device; including said any permanently secured said any universal joint said any permanently secured to said any shackle coupling structure thus interchangeable comprising said any shackle; including said any permanently secured said any universal joint adaptor said any permanently secured to said any shackle coupling structure thus interchangeable comprising said any shackle; including said any permanently secured said any universal joint said any permanently secured to said any shackle coupling structure thus interchangeable comprising said any shackle; including said any permanently secured said any universal joint adaptor said any permanently secured to said any shackle coupling structure adaptor thus interchangeable comprising said any shackle; including said any permanently secured said any universal joint said any permanently secured to said any shackle coupling structure adaptor thus interchangeable comprising said any shackle; including said any permanently secured said any universal joint said any permanently secured to said any socket insert wherein said any hub of said any greater length extending said any distance; including said any permanently secured said any universal joint said any permanently secured to said any socket insert wherein said any hub of said any greater length extending said any distance; including said any permanently secured said any universal joint adaptor said any permanently secured to said any socket insert wherein said any hub of said any greater length extending said any distance; including said any permanently secured said any universal joint said any permanently secured to said any ratchet insert wherein said any hub of said any greater length extending said any distance; including said any permanently secured said any universal joint adaptor said any permanently secured to said any ratchet insert wherein said any hub of said any greater length extending said any distance; including said any permanently secured said any universal joint comprising said any manner of temporary securing said any device to said any permanently secured said any universal joint; including said any permanently secured said any universal joint adaptor comprising said any manner of temporary securing said any device to said any permanently secured said any universal joint; including said any permanently secured said any universal joint comprising said any additional appendage; including said any permanently secured said any universal joint adaptor comprising said any additional appendage; including said any permanently secured said any universal joint adaptor comprising said any additional appendage; including said any permanently secured said any universal joint said any permanently secured to said any rotary accessory device and the like said any interchangeable in said any manner; including said any permanently secured said any universal joint adaptor said any permanently secured to said any rotary accessory device and the like said any interchangeable in said any manner; including said any permanently secured said any universal joint said any permanently secured to said any rotary accessory device and the like adaptor said any interchangeable in said any manner; including said any permanently secured said any universal joint comprising said compelling device said any internal of said any permanently secured said any universal joint; including said any permanently secured said any universal joint adaptor comprising said compelling device said any internal of said any permanently secured said any universal joint; including said any permanently secured said any universal joint comprising said any stepped said any internal surface interior of said any aperture within said any permanently secured said any universal joint; including said any permanently secured said any universal joint adaptor comprising said any stepped said any internal surface interior of said any aperture within said any permanently secured said any universal joint; including said any permanently secured said any universal joint comprising said any additional appendage operatively workable comprising said any threaded fastening device; including said any permanently secured said any universal joint adaptor comprising said any additional appendage operatively workable comprising said any threaded fastening device; including said any permanently secured said any universal joint comprising said any additional appendage adaptor operatively workable comprising said any threaded securing device; including said any permanently secured said any universal joint comprising said any hex formed said any aperture within said any permanently secured said any universal joint; including said any permanently secured said any universal joint adaptor comprising said any hex formed said any aperture within said any permanently secured said any universal joint; including said any permanently secured said any universal joint comprising said any hex formed output stud projecting said any outwardly orthogonnally projecting beyond said any upmost portion of said any permanently secured said any universal joint; including said any permanently secured said any universal joint adaptor comprising said any hex formed output stud projecting said any outwardly orthogonnally beyond said any upmost portion of said any permanently secured said any universal joint; including said any permanently secured said any universal joint comprising said any hex formed output stud projecting said any outwardly said any angularly projecting beyond said any upmost portion of said any permanently secured said any universal joint; including said any permanently secured said any universal joint adaptor comprising said any hex formed output stud projecting said any outwardly said any angularly beyond said any upmost portion of said any permanently secured said any universal joint; including said any permanently secured said any universal joint comprising said any hex formed said any aperture descending said any inwardly orthogonnally in relation to said any upmost portion of said any permanently secured said any universal joint; including said any permanently secured said any universal joint adaptor comprising said any hex formed said any aperture descending said any inwardly orthogonnally in relation to said any upmost portion of said any permanently secured said any universal joint; including said any permanently secured said any universal joint comprising said any hex formed said any aperture descending said any inwardly said any angularly in relation to said any upmost portion of said any permanently secured said any universal joint; including said any permanently secured said any universal joint adaptor comprising said any hex formed said any aperture descending said any inwardly said any angularly in relation to said any upmost portion of said any permanently secured said any universal joint; including said any permanently secured said any universal joint comprising said any adjustable members formed as part of said any permanently secured said any universal joint; including said any permanently secured said any universal joint adaptor comprising said any adjustable members formed as part of said any permanently secured said any universal joint; including said any permanently secured said any universal joint adaptor comprising said any adjustable members formed as part of said any permanently secured said any universal joint adaptor; including said any permanently secured said any universal joint said any permanently secured to said any ratchet insert upon said any battery compelled said any fully assembled said any Dual Ratchet Mechanism; including said any permanently secured said any universal joint adaptor said any permanently secured to said any ratchet insert upon said any battery compelled said any Dual Ratchet Mechanism; including said any permanently secured said any universal joint said any permanently secured to said any socket insert upon said any battery compelled said any Dual Ratchet Mechanism; including said any permanently secured said any universal joint adaptor said any permanently secured to said any socket insert upon said any battery compelled said any Dual Ratchet Mechanism; including said any permanently secured said any universal joint comprising said any output stud; including said any permanently secured said any universal joint adaptor comprising said any output stud; including said any permanently secured said any universal joint comprising said any output stud adaptor; including said any permanently secured said any universal joint said any output stud said any permanently secured to said any adaptor comprising said any square aperture section upon one section and upon opposite section of said any adaptor comprising said any adaptor section; including said any permanently secured said any universal joint adaptor said any output stud said any permanently secured to said any adaptor comprising said any square aperture section upon one section and upon opposite section of said any adaptor comprising said any adaptor section; including said any permanently secured said any universal joint said any permanently secured to said any adaptor in said any manner; including said any permanently secured said any universal joint adaptor said any permanently secured to said any adaptor in said any manner; including said any permanently secured said any universal joint said any permanently secured to said any socket insert upon one section and upon said opposite section said any universal swivel adaptor said any permanently secured to said any aperture of said any permanently secured said any universal joint; including said any permanently secured said any universal joint adaptor said any permanently secured to said any socket insert upon one section and upon said opposite section said any universal swivel adaptor said any permanently secured to said any aperture of said any permanently secured said any universal joint; including said any permanently secured said any universal joint adaptor said any permanently secured to said any socket insert upon one section and upon said opposite section said any universal swivel adaptor said any permanently secured to said any aperture of said any permanently secured said any universal joint adaptor; including said any permanently secured said any universal joint said any permanently secured to said any socket insert upon one section and upon said opposite section said any universal swivel adaptor said any permanently secured to said any aperture of said any permanently secured said any universal joint adaptor; including said any permanently secured said any universal joint said any permanently secured to said any socket insert upon one section and upon said opposite section said any universal joint adaptor said any permanently secured to said any aperture of said any permanently secured said any universal joint; including said any permanently secured said any universal joint said any permanently secured to said any ratchet insert upon one section and upon said opposite section said any universal swivel adaptor said any permanently secured to said any output stud upon said any permanently secured said any universal joint; including said any permanently secured said any universal joint adaptor said any permanently secured to said any ratchet insert upon one section and upon said opposite section said any universal swivel adaptor said any permanently secured to said any output stud upon said any permanently secured said any universal joint; including said any permanently secured said any universal joint adaptor said any permanently secured to said any ratchet insert upon one section and upon said opposite section said any universal swivel adaptor said any permanently secured to said any output stud upon said any permanently secured said any universal joint adaptor; including said any permanently secured said any universal joint said any permanently secured to said any ratchet insert upon one section and upon said opposite section said any universal swivel adaptor said any permanently secured to said any output stud upon said any permanently secured said any universal joint adaptor; including said any permanently secured said any universal joint said any permanently secured to said any ratchet insert upon one section and upon said opposite section said any universal joint adaptor said any permanently secured to said any output stud upon said any permanently secured said any universal joint; including said any permanently secured said any universal joint said any permanently secured to said any ratchet insert said smooth cylindrical outer surface comprising said any outside diameter in either section; including said any permanently secured said any universal joint adaptor said any permanently secured to said any ratchet insert said smooth cylindrical outer surface comprising said any outside diameter in either section; including said any permanently secured said any universal joint said any permanently secured to said any gear comprising said any interchangeable device; including said any permanently secured said any universal joint adaptor said any permanently secured to said any gear comprising said any interchangeable device; including said any permanently secured said any universal joint said any permanently secured to said any gear comprising said any output stud; including said any permanently secured said any universal joint adaptor said any permanently secured to said any gear comprising said any output stud; including said any permanently secured said any universal joint said any permanently secured to said any gear comprising said any output stud of said any form; including said any permanently secured said any universal joint adaptor said any permanently secured to said any gear comprising said any output stud of said any form; including said any permanently secured said any universal joint said any permanently secured to said any compelling device; including said any permanently secured said any universal joint adaptor said any permanently secured to said any compelling device; including said any permanently secured said any universal joint said any permanently secured to said any compelling device adaptor; including said any permanently secured said any universal joint said any permanently secured to said any socket insert altered comprising said any rotary accessory device upon said any socket insert; including said any permanently secured said any universal joint adaptor said any permanently secured to said any socket insert altered comprising said any rotary accessory device upon said any socket insert; including said any permanently secured said any universal joint said any permanently secured to said any socket insert altered comprising said any rotary accessory device adaptor upon said any socket insert; including said any permanently secured said any universal joint said any permanently secured to said any socket insert altered comprising said any rotary accessory device upon said any ratchet insert; including said any permanently secured said any universal joint adaptor said any permanently secured to said any socket insert altered comprising said any rotary accessory device upon said any ratchet insert; including said any permanently secured said any universal joint said any permanently secured to said any socket insert altered comprising said any rotary accessory device adaptor upon said any ratchet insert; including said any permanently secured said any universal joint said any permanently secured to said any socket insert comprising said any outwardly orthogonal said any threadably mountable member; including said any permanently secured said any universal joint adaptor said any permanently secured to said any socket insert comprising said any outwardly orthogonal said any threadably mountable member; including said any permanently secured said any universal joint said any permanently secured to said any socket insert comprising said any outwardly orthogonal said any threadably mountable member adaptor; including said any permanently secured said any universal joint said any permanently secured to said any ratchet insert comprising said any outwardly orthogonal said any threadably mountable member; including said any permanently secured said any universal joint adaptor said any permanently secured to said any ratchet insert comprising said any outwardly orthogonal said any threadably mountable member; including said any permanently secured said any universal joint said any permanently secured to said any ratchet insert comprising said any outwardly orthogonal said any threadably mountable member adaptor; including said any permanently secured said any universal joint said any permanently secured to said any socket insert comprising said any inwardly orthogonal said any threadably mountable member; including said any permanently secured said any universal joint adaptor said any permanently secured to said any socket insert comprising said any inwardly orthogonal said any threadably mountable member; including said any permanently secured said any universal joint said any permanently secured to said any socket insert comprising said any inwardly orthogonal said any threadably mountable member adaptor; including said any permanently secured said any universal joint said any permanently secured to said any ratchet insert comprising said any inwardly orthogonal said any threadably mountable member; including said any permanently secured said any universal joint adaptor said any permanently secured to said any ratchet insert comprising said any inwardly orthogonal said any threadably mountable member; including said any permanently secured said any universal joint said any permanently secured to said any ratchet insert comprising said any inwardly orthogonal said any threadably mountable member adaptor; including said any permanently secured said any universal joint said any permanently secured to said any socket insert comprising said any outwardly said any angular said any threadably mountable member; including said any permanently secured said any universal joint adaptor said any permanently secured to said any socket insert comprising said any outwardly said any angular said any threadably mountable member; including said any permanently secured said any universal joint said any permanently secured to said any socket insert comprising said any outwardly said any angular said any threadably mountable member adaptor; including said any permanently secured said any universal joint said any permanently secured to said any ratchet insert comprising said any outwardly said any angular said any threadably mountable member; including said any permanently secured said any universal joint adaptor said any permanently secured to said any ratchet insert comprising said any outwardly said any angular said any threadably mountable member; including said any permanently secured said any universal joint said any permanently secured to said any ratchet insert comprising said any outwardly said any angular said any threadably mountable member adaptor; including said any permanently secured said any universal joint said any permanently secured to said any socket insert comprising said any inwardly said any angular said any threadably mountable member; including said any permanently secured said any universal joint adaptor said any permanently secured to said any socket insert comprising said any inwardly said any angularly said any threadably mountable member; including said any permanently secured said any universal joint said any permanently secured to said any socket insert comprising said any inwardly said any angular said any threadably mountable member adaptor; including said any permanently secured said any universal joint said any permanently secured to said any ratchet insert comprising said any inwardly said any angular said any threadably mountable member; including said any permanently secured said any universal joint adaptor said any permanently secured to said any ratchet insert comprising said any inwardly said any angularly said any threadably mountable member; including said any permanently secured said any universal joint said any permanently secured to said any ratchet insert comprising said any inwardly said any angular said any threadably mountable member adaptor; including said any permanently secured said any universal joint said any permanently secured to said any ratchet insert said any permanently secured to said gear in said any manner; including said any permanently secured said any universal joint adaptor said any permanently secured to said any ratchet insert said any permanently secured to said gear in said any manner; including said any permanently secured said any universal joint comprising said any setscrew structure adaptor; including said any permanently secured said any universal joint said any permanently secured to said any socket insert comprising said any setscrew structure projecting said any outwardly orthogonnally in relation to said any permanently secured said any universal joint; including said any permanently secured said any universal joint said any permanently secured to said any socket insert comprising said any setscrew structure adaptor projecting said any outwardly orthogonnally in relation to said any permanently secured said any universal joint; including said any permanently secured said any universal joint adaptor said any permanently secured to said any socket insert comprising said any setscrew structure projecting said any outwardly orthogonnally in relation to said any permanently secured said any universal joint adaptor; including said any permanently secured said any universal joint adaptor said any permanently secured to said any socket insert comprising said any setscrew structure adaptor projecting said any outwardly orthogonnally in relation to said any permanently secured said any universal joint adaptor; including said any permanently secured said any universal joint said any permanently secured to said any socket insert comprising said any setscrew structure projecting said any outwardly said any angularly in relation to said any permanently secured said any universal joint; including said any permanently secured said any universal joint said any permanently secured to said any socket insert comprising said any setscrew structure adaptor projecting said any outwardly said any angularly in relation to said any permanently secured said any universal joint; including said any permanently secured said any universal joint said any permanently secured to said any socket insert comprising said any setscrew structure adaptor projecting said any outwardly said any angularly in relation to said any permanently secured said any universal joint; including said any permanently secured said any universal joint adaptor said any permanently secured to said any socket insert comprising said any setscrew structure projecting said any outwardly said any angularly in relation to said any permanently secured said any universal joint adaptor; including said any permanently secured said any universal swivel adaptor said any permanently secured to said any socket insert comprising said any setscrew structure adaptor projecting said any outwardly said any angularly in relation to said any permanently secured said any universal swivel adaptor; including said any universal joint said any permanently secured to said any socket insert; including said any universal joint adaptor said any permanently secured to said any output stud upon said any socket insert; including said any universal joint said any permanently secured to said any permanently secured to said any square aperture; including said any universal joint adaptor said any permanently secured to said any square aperture within said any ratchet insert; including said any permanently secured universal joint comprising said any permanently secured said any self-powered device; including said any permanently secured universal joint adaptor comprising said any permanently secured said any self- powered device; including said any universal joint comprising said any temporarily secured said any self-powered device; including said any universal joint adaptor comprising said any temporarily secured said any self-powered device; including said any universal joint comprising said any self-powered device formed as part of said any universal joint in said any manner; including said any universal joint adaptor comprising said any self-powered device formed as part of said any universal joint adaptor in said any manner; including said any permanently secured said any universal joint comprising said any permanently secured said any element upon said any torque transmitting gun; including said any permanently secured said any universal joint adaptor comprising said any permanently secured said any element upon said any torque transmitting gun; including said any permanently secured said any universal joint comprising said any temporarily secured said any element upon said any torque transmitting gun; including said any permanently secured said any universal joint adaptor comprising said any temporarily secured said any element upon said any torque transmitting gun; including said any permanently secured said any universal joint formed as part of said any element upon said any torque transmitting gun; including said any permanently secured said any universal joint adaptor formed as part of said any element upon said any torque transmitting gun; including said any permanently secured said any universal joint comprising said any permanently secured said any element upon said any torque transmitting device; including said any permanently secured said any universal joint adaptor comprising said any permanently secured said any element upon said any torque transmitting device; including said any permanently secured said any universal joint comprising said any temporarily secured said any element upon said any torque transmitting device; including said any permanently secured said any universal joint adaptor comprising said any temporarily secured said any element upon said any torque transmitting device; including said any permanently secured said any universal joint formed as part of said any element upon said any torque transmitting device; including said any permanently secured said any universal joint adaptor formed as part of said any element upon said any torque transmitting device; including said any permanently secured said any universal joint comprising said any permanently secured said any form extension; including said any permanently secured said any universal joint adaptor comprising said any permanently secured said any form extension; including said any permanently secured said any universal joint comprising said any permanently secured said any form extension; including said any permanently secured said any universal joint adaptor comprising said any permanently secured said any form extension; including said any permanently secured said any universal joint formed as part of said any form extension; including said any permanently secured said any universal joint adaptor formed as part of said any form extension; including said any permanently secured said any universal joint said any permanently secured comprising said any interchangeable said any device; including said any permanently secured said any universal joint adaptor said any permanently secured comprising said any interchangeable said any device; including said any permanently secured said any universal joint said any temporarily secured comprising said any interchangeable said any device; including said any permanently secured said any universal joint adaptor said any temporarily secured comprising said any interchangeable said any device; including said any permanently secured said any universal joint formed as part of said any interchangeable said any device; including said any permanently secured said any universal joint adaptor said any formed as part of said any interchangeable said any device; including permanently secured said any universal joint adaptor said any permanently secured to said any device in said any manner; including said any permanently secured said any universal joint comprising said any temporarily secured to said any device in said any manner; including said any permanently secured said any universal joint adaptor comprising said any temporarily secured to said any device in said any manner; including said any universal joint comprising said any temporarily secured said any clamping device; including said any universal joint adaptor comprising said any temporarily secured said any clamping device; including said any universal joint formed as part of said any clamping device; including said any universal joint adaptor formed as part of said any clamping device; including said any permanently secured said any universal joint said any rotatably mounted upon said any angular hub comprising said any permanently secured said any bearing; including said any permanently secured said any universal joint adaptor said any rotatably mounted upon said any angular hub comprising said any permanently secured said any bearing; including said any permanently secured said any universal joint said any rotatably mounted upon said any orthogonal hub comprising said any permanently secured said any bearing; including said any permanently secured said any universal joint adaptor said any rotatably mounted upon said any orthogonal hub comprising said any permanently secured said any bearing; including said any permanently secured said any universal joint said any rotatably mounted upon said any form orthogonal hub comprising said any permanently secured said any bearing; including said any permanently secured universal joint adaptor said any rotatably mounted upon said any form orthogonal hub comprising said any permanently secured said any bearing; including said any permanently secured said any universal joint said any rotatably mounted upon said any form angular hub comprising said any permanently secured said any bearing; including said any permanently secured said any universal joint adaptor said any rotatably mounted upon said any form angular hub comprising said any permanently secured said any bearing; including said any permanently secured said any universal joint comprising said any bearing said any rotatably mounted upon said any form orthogonal hub; including said any permanently secured said any universal joint adaptor comprising said any bearing said any rotatably mounted upon said any form orthogonal hub; including said any permanently secured said any universal joint comprising said any permanently secured bearing said any rotatably mounted upon said any form said any angular hub; including said any permanently secured said any universal joint adaptor comprising said any permanently secured said any bearing said any rotatably mounted upon said any form said any angular hub; including said any permanently secured bearing said any permanently secured to said any permanently secured universal joint; including said any permanently secured bearing said any permanently secured to said any permanently secured universal joint adaptor; including said any permanently secured universal joint said any rotatably mounted upon said any orthogonal hub of said any greater length; including said any permanently secured universal joint adaptor said any rotatably mounted upon said any orthogonal hub of said any greater length; including said any permanently secured universal joint said any rotatably mounted upon said any orthogonal hub of said any greater length comprising said any bearing; including said any permanently secured universal joint adaptor said any rotatably mounted upon said any orthogonal hub of said any greater length comprising said any bearing; including said any permanently secured universal joint said any rotatably mounted upon said any angular hub of said any greater length; including said any permanently secured universal joint adaptor said any rotatably mounted upon said any angular hub of said any greater length; including said any permanently secured universal joint said any rotatably mounted upon said any angular hub of said any greater length comprising said any bearing; including said any permanently secured universal joint adaptor said any rotatably mounted upon said any angular hub of said any greater length comprising said any bearing; including said any permanently secured universal joint said any rotatably mounted upon said any form hub of said any greater length; including said any permanently secured universal joint adaptor said any rotatably mounted upon said any form hub of said any greater length; including said any permanently secured universal joint said any rotatably mounted upon said any form hub of said any greater length comprising said any bearing; including said any permanently secured universal joint adaptor said any rotatably mounted upon said any form hub of said any greater length comprising said any bearing; including said any permanently secured universal joint said any rotatably mounted upon said any hub of said any greater length; including said any permanently secured universal joint adaptor said any rotatably mounted upon said any hub of said any greater length; including said any permanently secured universal joint said any rotatably mounted upon said any hub of said any greater length comprising said any bearing; including said any permanently secured universal joint adaptor said any rotatably mounted upon said any hub of said any greater length comprising said any bearing; including said any permanently secured universal joint adaptor said any rotatably mounted upon said any hub of said any greater length comprising said any bearing; including said any permanently secured said any universal joint comprising said any permanently secured said any ratcheting device; including said any permanently secured said any universal joint adaptor comprising said any permanently secured said any ratcheting device; including said any socket of greater depth said any permanently secured to said any permanently secured said any universal joint; including said any socket of greater depth said any permanently secured to said any permanently secured said any universal joint adaptor; including said any socket of greater depth adaptor said any permanently secured to said any permanently secured said any universal joint; including said any socket of greater depth adaptor said any permanently secured to said any permanently secured said any universal joint adaptor; including said any shaft said any permanently secured to said any permanently secured said any universal joint; including said any shaft said any permanently secured to said any permanently secured said any universal joint adaptor; including said any shaft adaptor said any permanently secured to said any permanently secured said any universal joint; including said any self-forming socket said any permanently secured to said any permanently secured said any universal joint; including said any self-forming socket adaptor said any permanently secured to said any permanently secured said any universal joint; including said any self-forming socket said any permanently secured to said any permanently secured said any universal joint adaptor; including said any self-forming socket adaptor said any permanently secured to said any permanently secured said any universal joint adaptor; including said any shaft adaptor said any permanently secured to said any permanently secured said any universal joint adaptor; including said any coupling structure adaptor said any permanently secured to said any permanently secured said any universal joint; including said any coupling structure said any permanently secured to said any permanently secured said any universal joint adaptor; including said any shackle coupling structure adaptor said any permanently secured to said any permanently secured said any universal joint; including said any shackle coupling structure said any permanently secured to said any permanently secured said any universal joint adaptor; including said any battery powered device said any permanently secured to said any permanently secured said any universal joint; including said any battery powered device said any permanently secured to said any permanently secured said any universal joint adaptor; including said any battery powered device adaptor said any permanently secured to said any permanently secured said any universal joint; including said any battery powered device adaptor said any permanently secured to said any permanently secured said any universal joint adaptor; including said any extension said any permanently secured to said any universal joint; including said any extension adaptor said any permanently secured to said any universal joint; including said any extension said any permanently secured to said any universal joint adaptor; including said any extension adaptor said any permanently secured to said any universal joint adaptor; including said threaded securing device said any permanently secured to said any universal joint; including said threaded securing device said any permanently secured to said any universal joint adaptor; including said threaded securing device adaptor said any permanently secured to said any universal joint adaptor; including said threaded securing device adaptor said any permanently secured to said any universal joint; including said dual universal joints adaptor said any permanently secured to said any universal joint; including said dual universal joints adaptor said any permanently secured to said any universal joint adaptor; including said any hex formed said any output stud adaptor permanently secured to said any permanently secured said any universal joint; including said threaded securing device said any permanently secured to said any universal joint; including said threaded securing device said any permanently secured to said any universal joint adaptor; including said threaded securing device adaptor said any permanently secured to said any universal joint adaptor; including said threaded securing device adaptor said any permanently secured to said any universal joint; including said any internal hollow in one part that receives said any other said any corresponding part adaptor said any permanently secured to said any permanently secured said any universal joint; including said any internal hollow in one part that receives said any other said any corresponding part adaptor said any permanently secured to said any permanently secured said any universal joint adaptor; including said any hex formed said any output stud adaptor said any permanently secured to said any output stud upon said any permanently secured said any universal joint; including said any internal hollow in one part that receives said any other said any corresponding part adaptor said any permanently secured to said any output stud upon said any permanently secured said any universal joint; including said any internal hollow in one part that receives said any other said any corresponding part adaptor said any permanently secured to said any output stud upon said any permanently secured said any universal joint adaptor; including said any hex formed said any output stud adaptor said any permanently secured to said any aperture within said any permanently secured said any universal joint; including said any internal hollow in one part that receives said any other said any corresponding part adaptor said any permanently secured to said any aperture within said any permanently secured said any universal joint; including said any internal hollow in one part that receives said any other said any corresponding part adaptor said any permanently secured to said any aperture within said any permanently secured said any universal joint adaptor; including said any battery compelled device said any permanently secured to said any permanently secured said any universal joint; including said any battery compelled device said any permanently secured to said any permanently secured said any universal joint adaptor; including said any battery compelled device adaptor said any permanently secured to said any permanently secured said any universal joint; including said any battery compelled device adaptor said any permanently secured to said any permanently secured said any universal joint adaptor; including said any battery compelled device said any permanently secured to said any output stud upon said any permanently secured said any universal joint; including said any battery compelled device said any permanently secured to said any output stud upon said any permanently secured said any universal joint adaptor; including said any battery compelled device adaptor said any permanently secured to said any output stud upon said any permanently secured said any universal joint; including said any battery compelled device adaptor said any permanently secured to said any output stud upon said any permanently secured said any universal joint adaptor; including said any battery compelled device said any permanently secured to said any aperture within said any permanently secured said any universal joint; including said any battery compelled device said any permanently secured to said any aperture within said any permanently secured said any universal joint adaptor; including said any battery compelled device adaptor said any permanently secured to said any aperture within said any permanently secured said any universal joint; including said any battery compelled device adaptor said any aperture within said any permanently secured to said any permanently secured said any universal joint adaptor; including said any means said any permanently secured to said any output stud upon said any permanently secured said any universal joint; including said any means said any permanently secured to said any output stud upon said any permanently secured said any universal joint adaptor; including said any means adaptor said any permanently secured to said any output stud upon said any permanently secured said any universal joint; including said any means adaptor said any permanently secured to said any output stud upon said any permanently secured said any universal joint adaptor; including said any means said any permanently secured to said any aperture within said any permanently secured said any universal joint; including said any means said any permanently secured to said any aperture within said any permanently secured said any universal joint adaptor; including said any means adaptor said any permanently secured to said any aperture within said any permanently secured said any universal joint; including said any means adaptor said any aperture within said any permanently secured said any permanently secured said any universal joint adaptor; including said any means said any permanently secured to said any permanently secured said any universal joint; including said any means said any permanently secured to said any permanently secured said any universal joint adaptor; including said any means adaptor said any permanently secured to said any permanently secured said any universal joint; including said any means adaptor said any permanently secured to said any permanently secured said any universal joint adaptor; including said any means said any permanently secured to said any aperture within said any permanently secured said any universal joint; including said any means said any permanently secured to said any permanently secured said any universal joint adaptor; including said any means adaptor said any permanently secured to said any permanently secured said any universal joint; including said any means adaptor said any permanently secured to said any permanently secured said any universal joint adaptor; including said any torque transmitting device said any permanently secured to said any permanently secured said any universal joint; including said any torque transmitting device adaptor said any permanently secured to said any permanently secured said any universal joint adaptor; including said any torque transmitting device said any permanently secured to said any output stud upon said any permanently secured said any output stud upon said any universal joint; including said any torque transmitting device adaptor said any permanently secured to said any output stud upon said any permanently secured said any universal joint adaptor; including said any torque transmitting device said any permanently secured to said any aperture within said any permanently secured said any universal joint; including said any torque transmitting device adaptor said any permanently secured to said any aperture within said any permanently secured said any universal joint adaptor; including said any pneumatic compelled device said any permanently secured to said any permanently secured said any universal joint; including said any pneumatic compelled device adaptor said any permanently secured to said any permanently secured said any universal joint adaptor; including said any pneumatic compelled device said any permanently secured to said any output stud upon said any permanently secured said any output stud upon said any universal joint; including said any pneumatic compelled device adaptor said any permanently secured to said any output stud upon said any permanently secured said any universal joint adaptor; including said any pneumatic compelled device said any permanently secured to said any aperture within said any permanently secured said any universal joint; including said any pneumatic compelled device adaptor said any permanently secured to said any aperture within said any permanently secured said any universal joint adaptor; including said any interchangeable compelling device said any permanently secured to said any output stud upon said any permanently secured said any output stud upon said any universal joint; including said any interchangeable compelling device adaptor said any permanently secured to said any output stud upon said any permanently secured said any universal joint adaptor; including said any socket adaptor said any permanently secured to said any permanently secured said any universal joint; including said any socket adaptor said any permanently secured to said any permanently secured said any universal joint adaptor; including said any socket adaptor said any permanently secured to said any output stud upon said any permanently secured said any universal joint; including said any socket adaptor said any permanently secured to said any output stud upon said any permanently secured said any universal joint adaptor; including said any socket adaptor said any permanently secured to said any aperture within said any permanently secured said any universal joint; including said any socket adaptor said any permanently secured to said any aperture within said any permanently secured said any universal joint adaptor; including said any ratchet insert comprising said any permanently secured said any self-powered device; including said any ratchet insert comprising said any permanently secured said any orthogonal self- powered device; including said any ratchet insert comprising said any permanently secured said any angular self- powered device; including said any ratchet insert comprising said any permanently secured said any self-powered device; including said any ratchet insert comprising said any self-powered device formed as part of said any ratchet insert in any manner; including said any permanently secured said any ratchet insert comprising said any permanently secured said any element upon said any torque transmitting gun; including said any permanently secured said any ratchet insert comprising said any temporarily secured said any element upon said any torque transmitting gun; including said any permanently secured said any ratchet insert formed as part of said any element upon said any torque transmitting gun; including said any permanently secured said any ratchet insert comprising said any permanently secured said any element upon said any torque transmitting device; including said any permanently secured said any ratchet insert comprising said any temporarily secured said any element upon said any torque transmitting device; including said any permanently secured said any ratchet insert formed as part of said any element upon said any torque transmitting device; including said any ratchet insert comprising said any permanently secured said any form extension; including said any ratchet insert comprising said any temporarily secured said any form extension; including said any ratchet insert formed as part of said any form extension; including said any ratchet insert said any permanently secured comprising said any interchangeable said any device; including said any ratchet insert said any temporarily secured comprising said any interchangeable said any device; including said any ratchet insert said any formed as part of said any interchangeable said any device; including said any ratchet insert comprising said any temporarily secured said any device; including said any ratchet insert comprising said any temporarily secured said any clamping device; including said any ratchet insert formed as part of said any clamping device; including said any ratchet insert said any rotatably mounted upon said any angular hub comprising said any permanently secured said any bearing; including said any ratchet insert said any rotatably mounted upon said any orthogonal hub said any permanently secured comprising said any bearing; including said any ratchet insert said any rotatably mounted upon said any form orthogonal hub comprising said any permanently secured said any bearing; including said any ratchet insert said any rotatably mounted upon said any form angular hub comprising said any permanently secured said any bearing; including said any ratchet insert comprising said any bearing said any rotatably mounted upon said any form orthogonal hub; including said any ratchet insert comprising said any permanently secured said any bearing said any rotatably mounted upon said any form said any angular hub; including said any permanently secured bearing said any permanently secured to said any ratchet insert; including said any ratchet insert said any rotatably mounted upon said any orthogonal hub of said any greater length; including said any ratchet insert said any rotatably mounted upon said any orthogonal hub of said any greater length comprising said any bearing; including said any ratchet insert said any rotatably mounted upon said any angular hub of said any greater length; including said any ratchet insert said any rotatably mounted upon said any angular hub of said any greater length comprising said any bearing; including said any ratchet insert said any rotatably mounted upon said any form hub of said any greater length; including said any ratchet insert said any rotatably mounted upon said any form hub of said any greater length comprising said any bearing; including said any ratchet insert said any rotatably mounted upon said any hub of said any greater length; including said any ratchet insert said any rotatably mounted upon said any hub of said any greater length comprising said any bearing; including said any permanently secured said any electrically compelled device said any permanently secured to said any ratchet insert; including said any ratchet insert comprising said any permanently secured said any ratcheting device; including said any socket of greater depth said any permanently secured to said any ratchet insert; including said any socket of greater depth adaptor said any permanently secured to said any ratchet insert; including said any shaft said any permanently secured to said any aperture upon said any ratchet insert; including said any shaft said any permanently secured to said any ratchet insert; including said any shaft adaptor said any permanently secured to said any aperture within said any ratchet insert; including said any shaft adaptor said any permanently secured to said any ratchet insert; including said any self-forming socket said any permanently secured to said any aperture within said any ratchet insert; including said any self-forming socket adaptor said any permanently secured to said any aperture within said any ratchet insert; including said any self-forming socket said any permanently secured to said any ratchet insert; including said any self-forming socket adaptor said any permanently secured to said any ratchet insert; including said any coupling structure said any permanently secured to said any ratchet insert; including said any coupling structure adaptor said any permanently secured to said any ratchet insert; including said any battery powered device said any permanently secured to said any aperture within said ratchet insert; including said any battery powered device adaptor said any permanently secured to said any aperture within said ratchet insert; including said any battery powered device said any permanently secured to said any ratchet insert; including said any battery powered device adaptor said any permanently secured to said ratchet insert; including said any extension said any permanently secured to said any universal swivel; including said any extension adaptor said any permanently secured to said any universal swivel; including said any extension said any permanently secured to said any universal swivel adaptor; including said any extension adaptor said any permanently secured to said any universal swivel adaptor; including said threaded securing device said any permanently secured to said any ratchet insert; including said threaded securing device adaptor said any permanently secured to said any ratchet insert; including said threaded securing device said any permanently secured to said any output stud upon said ratchet insert; including said threaded securing device adaptor said any permanently secured to said any output stud upon said ratchet insert; including said Dual universal swivel adaptor said any permanently secured to said any ratchet insert; including said Dual universal swivel adaptor said any permanently secured to said any aperture within said any ratchet insert; including said Dual universal joint adaptor said any permanently secured to said any ratchet insert; including said Dual universal joint adaptor said any permanently secured to said any aperture within said any ratchet insert; including said any hex formed said any output stud said any permanently secured to said any ratchet insert; including said any hex formed said any output stud adaptor said any permanently secured to said any ratchet insert; including said any hex formed said any output stud adaptor said any permanently secured to said any aperture within said any ratchet insert; including said any internal hollow in one part that receives any other corresponding part adaptor said any permanently secured to said any ratchet insert; including said any means said any permanently secured to said any ratchet insert; including said any means said any permanently secured to said any aperture within said any ratchet insert; including said any means adaptor said any permanently secured to said any ratchet insert; including said any means adaptor said any permanently secured to said any aperture within said any ratchet insert; including said any torque transmitting device said any permanently secured to said any ratchet insert; including said any torque transmitting device said any permanently secured to said any aperture within said any ratchet insert; including said any torque transmitting device adaptor said any permanently secured to said any ratchet insert; including said any torque transmitting device adaptor said any permanently secured to said any aperture within said any ratchet insert; including said any torque transmitting device adaptor said any permanently secured to said any output stud upon said any ratchet insert; including said any battery compelled device said any permanently secured to said any ratchet insert; including said any battery compelled device said any permanently secured to said any aperture within said any ratchet insert; including said any battery compelled device adaptor said any permanently secured to said any ratchet insert; including said any battery compelled device adaptor said any permanently secured to said any aperture within said any ratchet insert; including said any pneumatic compelled device said any permanently secured to said any ratchet insert; including said any pneumatic compelled device said any permanently secured to said any aperture within said any ratchet insert; including said any pneumatic compelled device adaptor said any permanently secured to said any ratchet insert; including said any pneumatic compelled device adaptor said any permanently secured to said any aperture within said any ratchet insert; including said any socket adaptor said any permanently secured to said any ratchet insert; including said any socket adaptor said any permanently secured to said any aperture within said any ratchet insert; including said any length said any ratchet insert projecting said any outwardly orthogonnally beyond said any outside face of said housing ratchet side; including said any length said any ratchet insert projecting said any outwardly angularly beyond said any outside face of said housing ratchet side; including said any permanently secured said any universal swivel comprising said any permanently secured said any extension adaptor; including said any permanently secured said any universal swivel said any permanently secured to said any threadably secured structure adaptor; including said any universal swivel comprising said any various supplementary detachable elements comprising said any rotatable said any coupling system incorporated with said any adapted output studs; including said any universal swivel comprising said any various supplementary detachable elements adaptor comprising said any rotatable said any coupling system incorporated with said any adapted output studs; including said any permanently secured said any universal swivel comprising said any foldable shaft adaptor including said any permanently secured said any universal swivel said any permanently secured to said any socket insert comprising said any foldable shaft adaptor; including said any permanently secured said any universal swivel said any permanently secured to said any ratchet insert comprising said any foldable shaft adaptor; including said any permanently secured said any universal swivel altered comprising said any chuck adaptor; including said any permanently secured said any universal swivel altered comprising said any orthogonal chuck adaptor projecting said any outwardly orthogonnally in relation to said any universal swivel; including said any permanently secured said any universal swivel altered comprising said any angular chuck adaptor projecting said any outwardly angularly in relation to said any universal swivel; including said any permanently secured said any universal swivel is said any permanently secured to said any socket insert said any workably mounted to said any housing ratchet side in said any manner; including said any permanently secured said any universal swivel adaptor said any permanently secured to said any socket insert said any workably mounted to said any housing ratchet side in said any manner; including said any permanently secured said any universal swivel adaptor said any permanently secured to said any fully assembled said any Dual Ratchet Mechanism wherein said any housing socket side and said any housing ratchet side are joined together in said any manner; including said any permanently secured said any universal swivel adaptor said any permanently secured to said any fully assembled said any Dual Ratchet Mechanism comprising said any convex outer surface; including said any permanently secured said any universal swivel adaptor said any permanently secured to said any fully assembled said any Dual Ratchet Mechanism wherein said any housing socket side and said housing ratchet side are joined together comprising the use of said any interlocking said any joint; including said any permanently secured said any universal swivel adaptor said any permanently secured to said any fully assembled said any Dual Ratchet Mechanism comprising said any gear utilized for said any triaxial gear arrangement; including said any permanently secured said any universal swivel adaptor said any permanently secured to said any fully assembled said any Dual Ratchet Mechanism comprising said any stop; including said any permanently secured said any universal swivel adaptor rotatably mounted upon said any form said any orthogonal hub upon said any housing socket side; including said any permanently secured said any universal swivel adaptor rotatably mounted upon said any form said any orthogonal hub upon said any housing ratchet side; including said any permanently secured said any universal swivel adaptor said any permanently secured to said any fully assembled said any Dual Ratchet Mechanism comprising said any number of said any detachable said any legs said any temporarily secured; including said any permanently secured said any universal swivel adaptor said any permanently secured to said Dual Ratchet Mechanism comprising said any components produced from said any substance; including said any permanently secured said any universal swivel adaptor comprising said any components produced from said any substance; including said any permanently secured said any universal swivel adaptor said any permanently secured to said any Dual Ratchet Mechanism said any permanently united to said any other said any Dual Ratchet Mechanism; including said any permanently secured said any universal swivel adaptor said any permanently secured to said any Dual Ratchet Mechanism said any temporarily united to said any other said any Dual Ratchet Mechanism; including said any permanently secured said any universal swivel adaptor said any permanently secured to said any fully assembled said any Dual Ratchet Mechanism comprising said any substance to form said any permanently secured said any object; including said any permanently secured said any universal swivel said any permanently secured to said Dual Ratchet Mechanism comprising said any means for said any temporarily securing said any fully assembled said any Dual Ratchet Mechanism to said any wire rope clip while operatively securing said any wire rope clip to said any wire rope; including said any permanently secured said any universal swivel adaptor said any permanently secured to said Dual Ratchet Mechanism comprising said any means for said any temporarily securing said any fully assembled said any Dual Ratchet Mechanism to said any wire rope clip while operatively securing said any wire rope clip to said any wire rope; including said any permanently secured said any universal swivel said any permanently secured to said Dual Ratchet Mechanism comprising said any means for said any temporarily securing said any fully assembled said any Dual Ratchet Mechanism to said any wire rope while operatively securing said any wire rope clip to said any wire rope; including said any permanently secured said any universal swivel adaptor said any permanently secured to said Dual Ratchet Mechanism comprising said any means for said any temporarily securing said any fully assembled said any Dual Ratchet Mechanism to said any wire rope while operatively securing said any wire rope clip to said any wire rope; including said any permanently secured said any universal swivel adaptor said any permanently secured to said Dual Ratchet Mechanism comprising said any housing ratchet side produced from said any substance; including said any permanently secured said any universal swivel adaptor said any permanently secured to said Dual Ratchet Mechanism comprising said any housing socket side produced from said any substance; including said any permanently secured said any universal swivel adaptor said any permanently secured to said Dual Ratchet Mechanism comprising said any gears produced from said any substance; including said any permanently secured said any universal swivel adaptor said any permanently secured to said any ratchet insert; produced from said any substance; including said any permanently secured said any universal swivel adaptor said any permanently secured to said any socket insert produced from said any substance; including said any permanently secured said any universal swivel adaptor said any permanently secured to said any fully assembled said any Dual Ratchet Mechanism comprising said any components magnetized; including said any permanently secured said any universal swivel adaptor said any permanently secured to said any socket insert projecting said any outwardly angularly beyond said any outside face of said housing socket side; including said any permanently secured said any universal swivel adaptor said any permanently secured to said any socket insert projecting said any outwardly orthogonnally beyond said any outside face of said housing socket side; including said any permanently secured said any universal swivel adaptor said any permanently secured to said any socket insert descending said any inwardly orthogonnally in relation to said any outside face of said any housing socket side; including said any permanently secured said any universal swivel adaptor said any permanently secured to said any socket insert descending said any inwardly angularly in relation to said any outside face of said any housing socket side; including said any universal swivel adaptor said any permanently secured to said any ratchet insert projecting said any outwardly said any angularly beyond said any outside face of said any housing ratchet side; including said any permanently secured said any universal swivel adaptor said any permanently secured to said any ratchet insert projecting said any outwardly orthogonnally beyond said any outside face of said any housing ratchet side; including said any permanently secured said any universal swivel adaptor said any permanently secured to said any ratchet insert descending inwardly orthogonnally relation to said any outside face of said any housing ratchet side; including said any permanently secured said any universal swivel adaptor said any permanently secured to said any ratchet insert descending said any inwardly angularly in relation to said any outside face of said any housing ratchet side; including said any permanently secured said any universal swivel adaptor said any permanently secured to said any fully assembled said any Dual Ratchet Mechanism comprising said any alteration; including said any permanently secured said any universal swivel adaptor said any permanently secured to said Dual Ratchet Mechanism comprising said any aperture that will operatively connect to said any detent from said any device; including said any permanently secured said any universal swivel adaptor said any permanently secured to said any fully assembled said any Dual Ratchet Mechanism comprising said any element upon said any torque transmitting gun formed as part of said any socket insert; including said any permanently secured said any universal swivel adaptor said any permanently secured to said any fully assembled said any Dual Ratchet Mechanism comprising said any element upon said torque transmitting gun formed as part of said any ratchet insert; including said any permanently secured said any universal swivel adaptor said any permanently secured to said any square aperture upon said any ratchet insert comprising said any indentation upon said any interior surface of said any square aperture; including said any permanently secured said any universal swivel adaptor said any permanently secured to said any ratchet insert comprising said any stepped said any internal surface interior of said square aperture; including said any permanently secured said any universal swivel adaptor said any permanently secured to said any stepped said any internal surface interior of said square aperture comprising said any number of said any steps; including said any permanently secured said any universal swivel adaptor said any permanently secured to said Dual Ratchet Mechanism comprising said any hollow in one part that receives said any other said any corresponding part formed as part of said any socket insert; including said any permanently secured said any universal swivel said any permanently secured to said any socket insert comprising said any hollow in one part that receives said any other said any corresponding part projecting said any outwardly orthogonnally beyond said any outside face of said any housing socket side; including said any permanently secured said any universal swivel adaptor said any permanently secured to said any socket insert comprising said any hollow in one part that receives said any other said any corresponding part projecting said any outwardly orthogonnally beyond said any outside face of said any housing socket side; including said any permanently secured said any universal swivel said any permanently secured to said any socket insert comprising said any hollow in one part that receives said any other said any corresponding part projecting said any outwardly said any angularly beyond said any outside face of said any housing socket side; including said any permanently secured said any universal swivel adaptor said any permanently secured to said any socket insert comprising said any hollow in one part that receives said any other said any corresponding part projecting said any outwardly said any angularly beyond said any outside face of said any housing socket side; including said any permanently secured said any universal swivel said any permanently secured to said any socket insert comprising said any hollow in one part that receives said any other said any corresponding part descending said any inwardly orthogonnally in relation to said outside face of said any housing socket side; including said any permanently secured said any universal swivel adaptor said any permanently secured to said any socket insert comprising said any hollow in one part that receives said any other said any corresponding part descending said any inwardly orthogonnally in relation to said outside face of said any housing socket side; including said any permanently secured said any universal swivel said any permanently secured to said any socket insert comprising said any hollow in one part that receives said any other said any corresponding part descending said any inwardly said any angularly in relation to said outside face of said any housing socket side; including said any permanently secured said any universal swivel adaptor said any permanently secured to said any socket insert comprising said any hollow in one part that receives said any other said any corresponding part descending said any inwardly said any angularly in relation to said outside face of said any housing socket side; including said any permanently secured said any universal swivel said any permanently secured to said any ratchet insert comprising said any hollow in one part that receives said any other said any corresponding part projecting said any outwardly orthogonnally beyond said any outside face of said any housing ratchet side; including said any permanently secured said any universal swivel adaptor said any permanently secured to said any ratchet insert comprising said any hollow in one part that receives said any other said any corresponding part projecting said any outwardly orthogonnally beyond said any outside face of said any housing ratchet side; including said any permanently secured said any universal swivel said any permanently secured to said any ratchet insert comprising said any hollow in one part that receives said any other said any corresponding part projecting said any outwardly said any angularly beyond said any outside face of said any housing ratchet side; including said any permanently secured said any universal swivel adaptor said any permanently secured to said any ratchet insert comprising said any hollow in one part that receives said any other said any corresponding part projecting said any outwardly said any angularly beyond said any outside face of said any housing ratchet side; including said any permanently secured said any universal swivel said any permanently secured to said any ratchet insert comprising said any hollow in one part that receives said any other said any corresponding part descending said any inwardly orthogonnally in relation to said outside face of said any housing ratchet side; including said any permanently secured said any universal swivel adaptor said any permanently secured to said any ratchet insert comprising said any hollow in one part that receives said any other said any corresponding part descending said any inwardly orthogonnally in relation to said outside face of said any housing ratchet side; including said any permanently secured said any universal swivel said any permanently secured to said any ratchet insert comprising said any hollow in one part that receives said any other said any corresponding part descending said any inwardly said any angularly in relation to said outside face of said any housing ratchet side; including said any permanently secured said any universal swivel adaptor said any permanently secured to said any ratchet insert comprising said any hollow in one part that receives said any other said any corresponding part descending said any inwardly said any angularly in relation to said outside face of said any housing ratchet side; including said any permanently secured said any universal swivel adaptor said any permanently secured to said any ratchet insert wherein said any cylindrical step omitted; including said any permanently secured said any universal swivel said any permanently secured to said any socket insert wherein said any cylindrical step omitted; including said any permanently secured said any universal swivel adaptor permanently secured to said any socket insert said any cylindrical step omitted; including said any permanently secured said any universal swivel adaptor permanently secured to said any ratchet insert wherein said any circumferential flange omitted; including said any permanently secured said any universal swivel adaptor permanently secured to said any socket insert wherein said any circumferential flange omitted; including said any permanently secured said any universal swivel adaptor comprising said any compelling device said any internal of said any permanently secured said any universal swivel; including said any permanently secured said any universal swivel adaptor permanently secured to said any universal joint; including said any permanently secured said any universal swivel said any permanently secured to said any universal joint adaptor; including said any permanently secured said any universal swivel adaptor permanently secured to said any universal joint adaptor; including said any permanently secured said any universal swivel adaptor said any permanently secured to said interchangeable said any universal joint; including said any permanently secured said any universal swivel said any permanently secured to said any interchangeable said any universal joint adaptor; including said any permanently secured said any universal swivel adaptor said any permanently secured to said interchangeable said any universal joint adaptor; including said any permanently secured said any universal swivel adaptor permanently secured to said any coupling structure thus interchangeable comprising said any device; including said any permanently secured said any universal swivel adaptor permanently secured to said any coupling structure adaptor thus interchangeable comprising said any device; including said any permanently secured said any universal swivel permanently secured to said any coupling structure adaptor thus interchangeable comprising said any device; including said any permanently secured said any universal swivel adaptor said any permanently secured to said any shackle coupling structure thus interchangeable comprising said any shackle; including said any permanently secured said any universal swivel adaptor said any permanently secured to said any shackle coupling structure adaptor thus interchangeable comprising said any shackle; including said any permanently secured said any universal swivel said any permanently secured to said any shackle coupling structure adaptor thus interchangeable comprising said any shackle; including said any permanently secured said any universal swivel adaptor said any permanently secured to said any socket insert wherein said any hub of any greater length extending any distance; including said any permanently secured said any universal swivel adaptor said any permanently secured to said any ratchet insert wherein said any hub of any greater length extending any distance; including said any permanently secured said any universal swivel adaptor comprising said any manner of temporary securing said any device to said any permanently secured said any universal swivel; including said any permanently secured said any universal swivel adaptor comprising said any additional appendage; including said any permanently secured said any universal swivel comprising said any additional appendage adaptor; including said any permanently secured said any universal swivel adaptor said any permanently secured to said any rotary accessory device and the like said any interchangeable in any manner; including said any permanently secured said any universal swivel said any permanently secured to said any rotary accessory device and the like adaptor said any interchangeable in any manner; including said any permanently secured said any universal swivel adaptor comprising said compelling device said any internal of said any permanently secured said any universal swivel; including said any permanently secured said any universal swivel adaptor comprising said any stepped said any internal surface interior of said any aperture within said any permanently secured said any universal swivel; including said any permanently secured said any universal swivel adaptor comprising said any additional appendage operatively workable comprising said any threaded fastening device; including said any permanently secured said any universal swivel comprising said any additional appendage adaptor operatively workable comprising said any threaded fastening device; including said any permanently secured said any universal swivel adaptor comprising said any hex formed said any aperture within said any permanently secured said any universal swivel; including said any permanently secured said any universal swivel comprising said any hex formed output stud projecting said any outwardly orthogonnally projecting beyond said any upmost portion of said any permanently secured said any universal swivel; including said any permanently secured said any universal swivel adaptor comprising said any hex formed output stud projecting said any outwardly orthogonnally projecting beyond said any upmost portion of said any permanently secured said any universal swivel; including said any permanently secured said any universal swivel comprising said any hex formed output stud projecting said any outwardly said any angularly projecting beyond said any upmost portion of said any permanently secured said any universal swivel; including said any permanently secured said any universal swivel adaptor comprising said any hex formed output stud projecting said any outwardly said any angularly projecting beyond said any upmost portion of said any permanently secured said any universal swivel; including said any permanently secured said any universal swivel comprising said any hex formed any aperture descending said any inwardly orthogonnally in relation to said any upmost portion of said any permanently secured said any universal swivel; including said any permanently secured said any universal swivel adaptor comprising said any hex formed any aperture descending said any inwardly orthogonnally in relation to said any upmost portion of said any permanently secured said any universal swivel; including said any permanently secured said any universal swivel comprising said any hex formed any aperture descending said any inwardly said any angularly in relation to said any upmost portion of said any permanently secured said any universal swivel; including said any permanently secured said any universal swivel adaptor comprising said any hex formed any aperture descending said any inwardly said any angularly in relation to said any upmost portion of said any permanently secured said any universal swivel; including said any permanently secured said any universal swivel adaptor comprising said any adjustable members formed as part of said any permanently secured said any universal swivel; including said any permanently secured said any universal swivel adaptor comprising said any adjustable members formed as part of said any permanently secured said any universal swivel adaptor; including said any permanently secured said any universal swivel adaptor said any permanently secured to said any socket insert upon said any battery compelled said any Dual Ratchet Mechanism; including said any permanently secured said any universal swivel said any permanently secured to said any socket insert upon said any battery compelled said any fully assembled said any Dual Ratchet Mechanism; including said any permanently secured said any universal swivel adaptor said any permanently secured to said any ratchet insert upon said any battery compelled said any Dual Ratchet Mechanism; including said any permanently secured said any universal swivel adaptor comprising said any output stud; including said any permanently secured said any universal swivel comprising said any output stud adaptor; including said any permanently secured said any universal swivel adaptor said any output stud said any permanently secured to said any adaptor comprising said any square aperture section upon one section and upon opposite section of said any adaptor comprising said any adaptor section; including said any permanently secured said any universal swivel adaptor said any permanently secured to said any adaptor in any said any manner; including said any permanently secured said any universal swivel said any permanently secured to said any socket insert upon one section and upon said any opposite section said any universal joint adaptor said any permanently secured to said any aperture of said any permanently secured said any universal swivel; including said any permanently secured said any universal swivel adaptor said any permanently secured to said any socket insert upon one section and upon said any opposite section said any universal joint adaptor said any permanently secured to said any aperture of said any permanently secured said any universal swivel; including said any permanently secured said any universal swivel adaptor said any permanently secured to said any socket insert upon one section and upon said any opposite section said any universal joint adaptor said any permanently secured to said any aperture of said any permanently secured said any universal swivel adaptor; including said any permanently secured said any universal swivel said any permanently secured to said any socket insert upon one section and upon said any opposite section said any universal joint adaptor said any permanently secured to said any aperture of said any permanently secured said any universal swivel adaptor; including said any permanently secured said any universal swivel said any permanently secured to said any socket insert upon one section and upon said any opposite section said any universal swivel adaptor said any permanently secured to said any aperture of said any permanently secured said any universal swivel; including said any permanently secured said any universal swivel said any permanently secured to said any ratchet insert upon one section and upon said any opposite section said any universal joint adaptor said any permanently secured to said any output stud upon said any permanently secured said any universal swivel; including said any permanently secured said any universal swivel adaptor said any permanently secured to said any ratchet insert upon one section and upon said any opposite section said any universal joint adaptor said any permanently secured to said any output stud upon said any permanently secured said any universal swivel; including said any permanently secured said any universal swivel adaptor said any permanently secured to said any ratchet insert upon one section and upon said any opposite section said any universal joint adaptor said any permanently secured to said any output stud upon said any permanently secured said any universal swivel adaptor; including said any permanently secured said any universal swivel said any permanently secured to said any ratchet insert upon one section and upon said any opposite section said any universal joint adaptor said any permanently secured to said any output stud upon said any permanently secured said any universal swivel adaptor; including said any permanently secured said any universal swivel said any permanently secured to said any ratchet insert upon one section and upon said any opposite section said any universal swivel adaptor said any permanently secured to said any output stud upon said any permanently secured said any universal swivel; including said any permanently secured said any universal swivel adaptor said any permanently secured to said any ratchet insert said smooth cylindrical outer surface comprising said any outside diameter in either section; including said any permanently secured said any universal swivel adaptor said any permanently secured to said any gear comprising said any interchangeable device; including said any permanently secured said any universal swivel said any permanently secured to any gear comprising said any output stud; including said any permanently secured said any universal swivel adaptor permanently secured to any gear comprising said any output stud; including said any permanently secured said any universal swivel adaptor permanently secured to said any gear comprising said any output stud of any form; including said any permanently secured said any universal swivel adaptor permanently secured to said any compelling device; including said any permanently secured said any universal swivel adaptor permanently secured to said any compelling device adaptor; including said any permanently secured said any universal swivel said any permanently secured to said any socket insert altered comprising said any rotary accessory device upon said any socket insert; including said any permanently secured said any universal swivel adaptor said any permanently secured to said any socket insert altered comprising said any rotary accessory device upon said any socket insert; including said any permanently secured said any universal swivel said any permanently secured to said any socket insert altered comprising said any rotary accessory device adaptor upon said any socket insert; including said any permanently secured said any universal swivel adaptor said any permanently secured to said any socket insert altered comprising said any rotary accessory device upon said any ratchet insert; including said any permanently secured said any universal swivel said any permanently secured to said any socket insert altered comprising said any rotary accessory device adaptor upon said any ratchet insert; including said any permanently secured said any universal swivel said any permanently secured to said any socket insert comprising said any outwardly orthogonal said any threadably mountable member; including said any permanently secured said any universal swivel adaptor permanently secured to said any socket insert comprising said any outwardly orthogonal said any threadably mountable member; including said any permanently secured said any universal swivel said any permanently secured to said any socket insert comprising said any outwardly orthogonal said any threadably mountable member adaptor; including said any permanently secured said any universal swivel said any permanently secured to said any ratchet insert comprising said any outwardly orthogonal said any threadably mountable member; including said any permanently secured said any universal swivel said any permanently secured to said any ratchet insert comprising said any outwardly orthogonal said any threadably mountable member adaptor; including said any permanently secured said any universal swivel said any permanently secured to said any socket insert comprising said any inwardly orthogonal said any threadably mountable member; including said any permanently secured said any universal swivel adaptor said any permanently secured to said any socket insert comprising said any inwardly orthogonal said any threadably mountable member; including said any permanently secured said any universal swivel said any permanently secured to said any socket insert comprising said any inwardly orthogonal said any threadably mountable member adaptor; including said any permanently secured said any universal swivel said any permanently secured to said any ratchet insert comprising said any inwardly orthogonal said any threadably mountable member; including said any permanently secured said any universal swivel adaptor said any permanently secured to said any ratchet insert comprising said any inwardly orthogonal said any threadably mountable member; including said any permanently secured said any universal swivel said any permanently secured to said any ratchet insert comprising said any inwardly orthogonal said any threadably mountable member adaptor; including said any permanently secured said any universal swivel said any permanently secured to said any socket insert comprising said any outwardly angular said any threadably mountable member; including said any permanently secured said any universal swivel adaptor said any permanently secured to said any socket insert comprising said any outwardly angular said any threadably mountable member; including said any permanently secured said any universal swivel said any permanently secured to said any socket insert comprising said any outwardly angular said any threadably mountable member adaptor; including said any permanently secured said any universal swivel said any permanently secured to said any ratchet insert comprising said any outwardly angular said any threadably mountable member; including said any permanently secured said any universal swivel adaptor said any permanently secured to said any ratchet insert comprising said any outwardly angular said any threadably mountable member; including said any permanently secured said any universal swivel said any permanently secured to said any ratchet insert comprising said any outwardly angular said any threadably mountable member adaptor; including said any permanently secured said any universal swivel said any permanently secured to said any socket insert comprising said any inwardly angular said any threadably mountable member; including said any permanently secured said any universal swivel adaptor said any permanently secured to said any socket insert comprising said any inwardly angular said any threadably mountable member; including said any permanently secured said any universal swivel said any permanently secured to said any socket insert comprising said any inwardly angular said any threadably mountable member adaptor; including said any permanently secured said any universal swivel said any permanently secured to said any ratchet insert comprising said any inwardly angular said any threadably mountable member; including said any permanently secured said any universal swivel adaptor said any permanently secured to said any ratchet insert comprising said any inwardly angular said any threadably mountable member; including said any permanently secured said any universal swivel said any permanently secured to said any ratchet insert comprising said any inwardly angular said any threadably mountable member adaptor; including said any permanently secured said any universal swivel said any permanently secured to said any ratchet insert said any permanently secured to said gear in any manner; including said any permanently secured said any universal swivel adaptor said any permanently secured to said any ratchet insert said any permanently secured to said gear in said any manner; including said any permanently secured said any universal swivel said any permanently secured to said any socket insert comprising said any setscrew structure projecting said any outwardly orthogonnally in relation to said any permanently secured said any universal swivel; including said any permanently secured said any universal swivel said any permanently secured to said any socket insert comprising said any setscrew structure adaptor projecting said any outwardly orthogonnally in relation to said any permanently secured said any universal swivel; including said any permanently secured said any universal swivel adaptor said any permanently secured to said any socket insert comprising said any setscrew structure projecting said any outwardly orthogonnally in relation to said any permanently secured said any universal swivel adaptor; including said any permanently secured said any universal swivel adaptor said any permanently secured to said any socket insert comprising said any setscrew structure adaptor projecting said any outwardly orthogonnally in relation to said any permanently secured said any universal swivel adaptor; including said any permanently secured said any universal swivel said any permanently secured to said any socket insert comprising, said any setscrew structure projecting said any outwardly angularly in relation to said any permanently secured said any universal swivel; including said any permanently secured said any universal swivel said any permanently secured to said any socket insert comprising said any setscrew structure adaptor projecting said any outwardly angularly in relation to said any permanently secured said any universal swivel; including said any permanently secured said any universal swivel said any permanently secured to said any socket insert comprising said any setscrew structure adaptor projecting said any outwardly angularly in relation to said any permanently secured said any universal swivel; including said any permanently secured said any universal swivel adaptor said any permanently secured to said any socket insert comprising said any setscrew structure projecting said any outwardly angularly in relation to said any permanently secured said any universal swivel adaptor; including said any permanently secured said any universal swivel adaptor said any permanently secured to said any socket insert comprising said any setscrew structure adaptor projecting said any outwardly angularly in relation to said any permanently secured said any universal swivel adaptor; including said any universal swivel said any permanently secured to said any socket insert; including said any universal swivel adaptor said any permanently secured to said any output stud upon said any socket insert; including said any universal swivel said any permanently secured to said any square aperture within said any ratchet insert; including said any universal swivel adaptor said any permanently secured to said any square aperture within said any ratchet insert; including said any permanently secured universal swivel comprising said any permanently secured said any self-powered device; including said any permanently secured universal swivel adaptor comprising said any permanently secured said any self- powered device; including said any universal swivel comprising said any temporarily secured said any self-powered device; including said any universal swivel adaptor comprising said any temporarily secured said any self-powered device; including said any universal swivel comprising said any self-powered device formed as part of said any universal swivel in any manner; including said any universal swivel comprising said any self-powered device formed as part of said any universal swivel adaptor in any manner; including said any permanently secured said any universal swivel comprising said any permanently secured said any element upon said any torque transmitting gun; including said any permanently secured said any universal swivel adaptor comprising said any permanently secured said any element upon said any torque transmitting gun; including said any permanently secured said any universal swivel comprising said any temporarily secured said any element upon said any torque transmitting gun; including said any permanently secured said any universal swivel adaptor comprising said any temporarily secured said any element upon said any torque transmitting gun; including said any permanently secured said any universal swivel formed as part of said any element upon said any torque transmitting gun; including said any permanently secured said any universal swivel adaptor formed as part of said any element upon said any torque transmitting gun; including said any permanently secured said any universal swivel comprising said any permanently secured said any element upon said any torque transmitting device; including said any permanently secured said any universal swivel adaptor comprising said any permanently secured said any element upon said any torque transmitting device; including said any permanently secured said any universal swivel comprising said any temporarily secured said any element upon said any torque transmitting device; including said any permanently secured said any universal swivel adaptor comprising said any temporarily secured said any element upon said any torque transmitting device; including said any permanently secured said any universal swivel formed as part of said any element upon said any torque transmitting device; including said any permanently secured said any universal swivel adaptor formed as part of said any element upon said any torque transmitting device; including said any permanently secured said any universal swivel comprising said any permanently secured said any form extension; including said any permanently secured said any universal swivel adaptor comprising said any permanently secured said any form extension; including said any permanently secured said any universal swivel comprising said any temporarily secured said any form extension; including said any permanently secured said any universal swivel adaptor comprising said any temporarily secured said any form extension; including said any permanently secured said any universal swivel formed as part of said any form extension; including said any permanently secured said any universal swivel adaptor formed as part of said any form extension; including said any permanently secured said any universal swivel said any permanently secured comprising said any interchangeable said any device; including said any permanently secured said any universal swivel adaptor said any permanently secured comprising said any interchangeable said any device; including said any permanently secured said any universal swivel said any temporarily secured comprising said any interchangeable said any device; including said any permanently secured said any universal swivel adaptor said any temporarily secured comprising said any interchangeable said any device; including said any permanently secured said any universal swivel said any formed as part of said any interchangeable said any device; including said any permanently secured said any universal swivel adaptor said any formed as part of said any interchangeable said any device; said any permanently secured said any universal swivel adaptor said any permanently secured to said any device in any manner; including said any permanently secured said any universal swivel comprising said any temporarily secured to said any device in said any manner; including said any permanently secured said any universal swivel adaptor comprising said any temporarily secured said any device in any manner; including said any universal swivel comprising said any temporarily secured said any clamping device; including said any universal swivel adaptor comprising said any temporarily secured said any clamping device; including said any universal swivel formed as part of said any clamping device; including said any universal swivel adaptor formed as part of said any clamping device; including said any permanently secured said any universal swivel said any rotatably mounted upon said any angular hub comprising said any permanently secured said any bearing; including said any permanently secured said any universal swivel adaptor said any rotatably mounted upon said any angular hub comprising said any permanently secured said any bearing; including said any permanently secured said any universal swivel said any rotatably mounted upon said any orthogonal hub comprising said any permanently secured said any bearing; including said any permanently secured said any universal swivel adaptor said any rotatably mounted upon said any orthogonal hub comprising said any permanently secured said any bearing; including said any permanently secured said any universal swivel said any rotatably mounted upon said any form orthogonal hub comprising said any permanently secured said any bearing; including said any permanently secured said any universal swivel adaptor said any rotatably mounted upon said any form orthogonal hub comprising said any permanently secured said any bearing; including said any permanently secured said any universal swivel said any rotatably mounted upon said any form angular hub comprising said any permanently secured said any bearing; including said any permanently secured said any universal swivel adaptor said any rotatably mounted upon said any form angular hub comprising said any permanently secured said any bearing; including said any permanently secured said any universal swivel comprising said any bearing said any rotatably mounted upon said any form orthogonal hub; including said any permanently secured said any universal swivel adaptor comprising said any bearing said any rotatably mounted upon said any form orthogonal hub; including said any socket insert comprising said any bearing said any rotatably mounted upon said any form orthogonal hub; including said any permanently secured said any universal swivel comprising said any permanently secured said any bearing said any rotatably mounted upon said any form said any angular hub; including said any permanently secured said any universal swivel adaptor comprising said any permanently secured said any bearing said any rotatably mounted upon said any form said any angular hub; including said any permanently secured bearing said any permanently secured to said any permanently secured universal joint; including said any permanently secured bearing said any permanently secured to said any permanently secured universal joint adaptor; including said any permanently secured universal swivel said any rotatably mounted upon said any orthogonal hub of said any greater length; including said any permanently secured universal swivel adaptor said any rotatably mounted upon said any orthogonal hub of said any greater length; including said any permanently secured universal swivel said any rotatably mounted upon said any orthogonal hub of said any greater length comprising said any bearing; including said any permanently secured universal swivel adaptor said any rotatably mounted upon said any orthogonal hub of said any greater length comprising said any bearing; including said any permanently secured universal swivel said any rotatably mounted upon said any angular hub of said any greater length; including said any permanently secured universal swivel adaptor said any rotatably mounted upon said any angular hub of said any greater length; including said any permanently secured universal swivel said any rotatably mounted upon said any angular hub of said any greater length comprising said any bearing; including said any permanently secured universal swivel adaptor said any rotatably mounted upon said any angular hub of said any greater length comprising said any bearing; including said any permanently secured universal swivel said any rotatably mounted upon said any form hub of said any greater length; including said any permanently secured universal swivel adaptor said any rotatably mounted upon said any form hub of said any greater length; including said any permanently secured universal swivel said any rotatably mounted upon said any form hub of said any greater length comprising said any bearing; including said any permanently secured universal swivel adaptor said any rotatably mounted upon said any form hub of said any greater length comprising said any bearing; including said any permanently secured universal swivel said any rotatably mounted upon said any hub of said any greater length; including said any permanently secured universal swivel adaptor said any rotatably mounted upon said any hub of said any greater length; including said any permanently secured universal swivel said any rotatably mounted upon said any hub of said any greater length comprising said any bearing; including said any permanently secured universal swivel adaptor said any rotatably mounted upon said any hub of said any greater length comprising said any bearing; including said any permanently secured said any universal swivel comprising said any permanently secured said any ratcheting device; including said any permanently secured said any universal swivel adaptor comprising said any permanently secured said any ratcheting device; including said any socket of greater depth said any permanently secured to said any permanently secured said any universal swivel; including said any socket of greater depth said any permanently secured to said any permanently secured said any universal swivel adaptor; including said any socket of greater depth adaptor said any permanently secured to said any permanently secured said any universal swivel; including said any socket of greater depth adaptor said any permanently secured to said any permanently secured said any universal swivel adaptor; including said any shaft said any permanently secured to said any permanently secured said any universal swivel; including said any shaft said any permanently secured to said any permanently secured said any universal swivel adaptor; including said any shaft adaptor said any permanently secured to said any permanently secured said any universal swivel; including said any shaft adaptor said any permanently secured to said any permanently secured said any universal swivel adaptor; including said any self-forming socket said any permanently secured to said any permanently secured said any universal swivel; including said any self-forming socket adaptor said any permanently secured to said any permanently secured said any universal swivel; including said any self-forming socket said any permanently secured to said any permanently secured said any universal swivel adaptor; including said any self-forming socket adaptor said any permanently secured to said any permanently secured said any universal swivel adaptor; including said any coupling structure adaptor said any permanently secured to said any permanently secured said any universal swivel adaptor; including said any battery powered device said any permanently secured to said any permanently secured said any universal swivel; including said any battery powered device said any permanently secured to said any permanently secured said any universal swivel adaptor; including said any battery powered device adaptor said any permanently secured to said any permanently secured said any universal swivel; including said any battery powered device adaptor said any permanently secured to said any permanently secured said any universal swivel adaptor; including said any extension said any permanently secured to said any universal swivel; including said any extension adaptor said any permanently secured to said any universal swivel; including said any extension said any permanently secured to said any universal swivel adaptor; including said any extension adaptor said any permanently secured to said any universal swivel adaptor; including said threaded securing device said any permanently secured to said any universal swivel; including said threaded securing device said any permanently secured to said any universal swivel adaptor; including said threaded securing device adaptor said any permanently secured to said any universal swivel adaptor; including said threaded securing device adaptor said any permanently secured to said any universal swivel; including said dual universal swivel adaptor said any permanently secured to said any universal swivel; including said dual universal swivel adaptor said any permanently secured to said any universal swivel adaptor; including said dual universal swivel adaptor said any permanently secured to said any socket insert; including said dual universal swivel adaptor said any permanently secured to said any output stud upon said any socket insert; including said any hex formed said any output stud adaptor said any permanently secured to said any permanently secured said any universal swivel; including said any internal hollow in one part that receives any other said any corresponding part adaptor said any permanently secured to said any permanently secured said any universal swivel; including said any internal hollow in one part that receives any other said any corresponding part adaptor said any permanently secured to said any permanently secured said any universal swivel adaptor; including said any hex formed said any output stud adaptor said any permanently secured to said any output stud upon said any permanently secured said any universal swivel; including said any internal hollow in one part that receives any other said any corresponding part adaptor said any permanently secured to said any output stud upon said any permanently secured said any universal swivel; including said any internal hollow in one part that receives any other said any corresponding part adaptor said any permanently secured to said any output stud upon said any permanently secured said any universal swivel adaptor; including said any hex formed said any output stud adaptor said any permanently secured to said any aperture within said any permanently secured said any universal swivel; including said any internal hollow in one part that receives any other said any corresponding part adaptor said any permanently secured to said any aperture within said any permanently secured said any universal swivel; including said any internal hollow in one part that receives any other said any corresponding part adaptor said any permanently secured to said any aperture within said any permanently secured said any universal swivel adaptor; including said any battery compelled device said any permanently secured to said any permanently secured said any universal swivel; including said any battery compelled device said any permanently secured to said any permanently secured said any universal swivel adaptor; including said any battery compelled device adaptor said any permanently secured to said any permanently secured said any universal swivel; including said any battery compelled device adaptor said any permanently secured to said any permanently secured said any universal swivel adaptor; including said any battery compelled device said any permanently secured to said any output stud upon said any permanently secured said any universal swivel; including said any battery compelled device said any permanently secured to said any output stud upon said any permanently secured said any universal swivel adaptor; including said any battery compelled device adaptor said any permanently secured to said any output stud upon said any permanently secured said any universal swivel; including said any battery compelled device adaptor said any permanently secured to said any output stud upon said any permanently secured said any universal swivel adaptor; including said any battery compelled device said any permanently secured to said any aperture within said any permanently secured said any universal swivel; including said any battery compelled device said any permanently secured to said any aperture within said any permanently secured said any universal swivel adaptor; including said any battery compelled device adaptor said any permanently secured to said any aperture within said any permanently secured said any universal swivel; including said any battery compelled device adaptor said any aperture within said any permanently secured to said any permanently secured said any universal swivel adaptor; including said any means said any permanently secured to said any output stud upon said any permanently secured said any universal swivel; including said any means said any permanently secured to said any output stud upon said any permanently secured said any universal swivel adaptor; including said any means adaptor said any permanently secured to said any output stud upon said any permanently secured said any universal swivel; including said any means adaptor said any permanently secured to said any output stud upon said any permanently secured said any universal swivel adaptor; including said any means said any permanently secured to said any aperture within said any permanently secured said any universal swivel; including said any means said any permanently secured to said any aperture within said any permanently secured said any universal swivel adaptor; including said any means adaptor said any permanently secured to said any aperture within said any permanently secured said any universal swivel; including said any means adaptor said any aperture within said any permanently secured to said any permanently secured said any universal swivel adaptor; including said any means said any permanently secured to said any permanently secured said any universal swivel; including said any means said any permanently secured to said any permanently secured said any universal swivel adaptor; including said any means adaptor said any permanently secured to said any permanently secured said any universal swivel; including said any means adaptor said any permanently secured to said any permanently secured said any universal swivel adaptor; including said any means said any permanently secured to said any permanently secured said any universal swivel; including said any means said any permanently secured to said any permanently secured said any universal swivel adaptor; including said any means adaptor said any permanently secured to said any aperture within said any permanently secured said any universal swivel; including said any means adaptor said any permanently secured to said any permanently secured said any universal swivel adaptor; including said any torque transmitting device said any permanently secured to said any permanently secured said any universal swivel; including said any torque transmitting device adaptor said any permanently secured to said any permanently secured said any universal swivel adaptor; including said any torque transmitting device said any permanently secured to said any permanently secured said any output stud upon said any permanently secured said any universal swivel; including said any torque transmitting device adaptor said any permanently secured to said any output stud upon said any permanently secured said any universal swivel adaptor; including said any torque transmitting device said any permanently secured to said any aperture within said any permanently secured said any universal swivel; including said any torque transmitting device adaptor said any permanently secured to said any aperture within said any permanently secured said any universal swivel adaptor; including said any pneumatic compelled device said any permanently secured to said any permanently secured said any universal swivel; including said any pneumatic compelled device adaptor said any permanently secured to said any permanently secured said any universal swivel adaptor; including said any pneumatic compelled device said any permanently secured to said any output stud upon said any permanently secured said any universal swivel; including said any pneumatic compelled device adaptor said any permanently secured to said any output stud upon said any permanently secured said any universal swivel adaptor; including said any pneumatic compelled device said any permanently secured to said any aperture within said any permanently secured said any universal swivel; including said any pneumatic compelled device adaptor said any permanently secured to said any aperture within said any permanently secured said any universal swivel adaptor; including said any socket adaptor said any permanently secured to said any permanently secured said any universal swivel; including said any socket adaptor said any permanently secured to said any permanently secured said any universal swivel adaptor; including said any socket adaptor said any permanently secured to said any permanently secured said any output stud upon said any permanently secured said any universal swivel; including said any socket adaptor said any permanently secured to said any output stud upon said any permanently secured said any universal swivel adaptor; including said any socket adaptor said any permanently secured to said any aperture within said any permanently secured said any universal swivel; including said any socket adaptor said any permanently secured to said any aperture within said any permanently secured said any universal swivel adaptor; including said any fully assembled said any Dual Ratchet Mechanism comprising said any permanently secured said any self-powered device; including said any frilly assembled said any Dual Ratchet Mechanism comprising said any permanently secured said any orthogonal self powered device; including said any fully assembled said any Dual Ratchet Mechanism comprising said any permanently secured said any angular self powered device; including said any fully assembled said any Dual Ratchet Mechanism comprising said any temporarily secured said any self-powered device; including said any fully assembled said any Dual Ratchet Mechanism comprising said any self-powered device formed as part of said any ratchet insert in any manner; including said any fully assembled said any Dual Ratchet Mechanism said any permanently secured comprising said any interchangeable said any device; including said any fully assembled said any Dual Ratchet Mechanism said any temporarily secured comprising said any interchangeable said any device; including said any fully assembled said any Dual Ratchet Mechanism said any formed as part of comprising said any interchangeable said any device; including said any fully assembled said any Dual Ratchet Mechanism comprising said any temporarily secured any device; including said any fully assembled said any Dual Ratchet Mechanism comprising said any temporarily secured said any clamping device; including said any fully assembled said any Dual Ratchet Mechanism formed as part of said any clamping device; including said any permanently secured said any electrically compelled device said any permanently secured to said any fully assembled said any Dual Ratchet Mechanism; including said any fully assembled said any Dual Ratchet Mechanism comprising said any permanently secured said any ratcheting device; including said any socket of greater depth said any permanently secured to said any fully assembled said any Dual Ratchet Mechanism; including said any socket of greater depth adaptor said any permanently secured to said any fully assembled said any Dual Ratchet Mechanism; including said any shaft said any permanently secured to said any fully assembled said any Dual Ratchet Mechanism; including said any shaft adaptor said any permanently secured to said any fully assembled said any Dual Ratchet Mechanism; including said any self-forming socket said any permanently secured to said any fully assembled said any Dual Ratchet Mechanism; including said any self-forming socket adaptor said any permanently secured to said any fully assembled said any Dual Ratchet Mechanism; including said any coupling structure adaptor said any permanently secured to said any fully assembled said any Dual Ratchet Mechanism; including said any battery powered device said any permanently secured to said any fully assembled said any Dual Ratchet Mechanism; including said any battery powered device adaptor said any permanently secured to said any fully assembled said any Dual Ratchet Mechanism; including said any threaded securing device said any permanently secured to said any fully assembled said any Dual Ratchet Mechanism; including said any threaded securing device adaptor said any permanently secured to said any fully assembled said any Dual Ratchet Mechanism; including said any dual universal swivel adaptor said any permanently secured to said any fully assembled said any Dual Ratchet Mechanism; including said any dual universal joint adaptor said any permanently secured to said any fully assembled said any Dual Ratchet Mechanism; including said permanently secured said any rotary accessory device adaptor said any permanently secured to said any fully assembled said any Dual Ratchet Mechanism; including said any threadably mountable member permanently secured to said any fully assembled said any Dual Ratchet Mechanism; including said any threadably mountable member adaptor said any permanently secured to said any fully assembled said any Dual Ratchet Mechanism; including said any hex formed said any output stud permanently secured to said any fully assembled said any Dual Ratchet Mechanism; including said any hex formed said any output stud adaptor said any permanently secured to said any fully assembled said any Dual Ratchet Mechanism; including said any internal hollow in one part that receives any other corresponding part adaptor said any permanently secured to said any fully assembled said any Dual Ratchet Mechanism; including said any battery compelled device said any permanently secured to said any fully assembled said any Dual Ratchet Mechanism; including said any battery compelled device adaptor said any permanently secured to said any fully assembled said any Dual Ratchet Mechanism; including said any means said any permanently secured to said any fully assembled said any Dual Ratchet Mechanism; including said any means adaptor said any permanently secured to said any fully assembled said any Dual Ratchet Mechanism; including said any torque transmitting device said any permanently secured to said any fully assembled said any Dual Ratchet Mechanism; including said any torque transmitting device adaptor said any permanently secured to said any fully assembled said any Dual Ratchet Mechanism; including said any pneumatic compelled device said any permanently secured to said any fully assembled said any Dual Ratchet Mechanism; including said any pneumatic compelled device adaptor said any permanently secured to said any fully assembled said any Dual Ratchet Mechanism; including said any interchangeable compelling device adaptor said any permanently secured to said any ratchet insert; including said any interchangeable compelling device adaptor said any permanently secured to said any aperture within said any ratchet insert; including said any interchangeable compelling device said any permanently secured to said any fully assembled said any Dual Ratchet Mechanism; including said any interchangeable compelling device adaptor said any permanently secured to said any fully assembled said any Dual Ratchet Mechanism; including said any form internal aperture said any permanently secured to said any fully assembled said any Dual Ratchet Mechanism; including said any form internal aperture adaptor said any permanently secured to said any fully assembled said any Dual Ratchet Mechanism; including said any compelling device said any permanently secured to said any fully assembled said any Dual Ratchet Mechanism; including said any compelling device adaptor said any permanently secured to said any fully assembled said any Dual Ratchet Mechanism; including said any socket said any permanently secured to said any fully assembled said any Dual Ratchet Mechanism; including said any socket adaptor said any permanently secured to said any fully assembled said any Dual Ratchet Mechanism; said any permanently secured said any torque transmitting device is said any permanently secured to said any ratchet insert thus allowing said any permanently secured said any ratcheting device and said any ratchet insert to rotate as one; be a permanently secured unit; ratchet and rotate bi-directionally and to allow said any Dual Ratchet Mechanism to work correctly as stated in the aforementioned claim 4
